(19) United States
(12) Patent Application Publication
(10) Pub. No.: US 2019/0131722 A1
(43) Pub. Date: May 2, 2019

(54) MOBILE TERMINAL

(71) Applicant: LG ELECTRONICS INC., Seoul (KR)

(72) Inventors: Seungwoo RYU, Seoul (KR); Wonkyong CHOI, Seoul (KR); Taehoon KIM, Seoul (KR); Youngil KIM, Seoul (KR); Jaehyuk KIM, Seoul (KR); Chaejoo LIM, Seoul (KR); Joohee LEE, Seoul (KR); Wonwoo LEE, Seoul (KR)

(73) Assignee: LG ELECTRONICS INC., Seoul (KR)

(21) Appl. No.: 16/095,333

(22) PCT Filed: Jan. 20, 2017
(86) PCT No.: PCT/KR2017/000742

§ 371 Date: Oct. 19, 2018

(30) Foreign Application Priority Data
Apr. 22, 2016 (KR) 10-2016-0049602
Jun. 21, 2016 (KR) 10-2016-0077584

(51) Int. Cl. H01Q 25/00; H01Q 1/24; H01Q 1/38

(52) U.S. Cl. CPC H01Q 25/005; H04M 1/0202; H01Q 1/38; H01Q 1/243

(57) ABSTRACT

The present invention relates to a mobile terminal comprising: a terminal body; a main circuit board disposed in the body; a main conductive member spaced apart from the main circuit board and radiating electromagnetic waves at an end thereof; and a frequency varying unit disposed between the main conductive member and the main circuit board so as to vary the resonant frequency of the main conductive member, wherein the frequency varying unit comprises: a power supply unit connected to the main circuit board; and one or more sub-conductive members disposed between the main conductive member and the power supply unit; spaced apart from each other, and supplied with power by the power supply unit, and wherein the sub-conductive members and the main conductive member are a predetermined distance apart from each other.

### TECHNICAL FIELD

The present disclosure relates to a mobile terminal having an antenna.

### BACKGROUND ART

Terminals may be divided into a mobile terminal (mobile/portable terminal) and a stationary terminal according to whether the terminal may be moved. The mobile terminal may be divided into a handheld terminal and a vehicle mounted terminal according to whether the user may carry the mobile phone directly.

The functions of mobile terminals are diversified. For example, there are functions of data and voice communication, photographing and video shooting through a camera, voice recording, music file playback through a speaker system, and outputting an image or video to a display unit. Some terminals are equipped with an electronic game play function or a multimedia player function. In particular, modern mobile terminals may receive multicast signals that provide visual content such as broadcast, video or television programs.

As functions are diversified, terminals are implemented in the form of multimedia devices supporting composite functions such as photographing or video shooting, music or video file playback, playing games, receiving broadcast, and the like.

Meanwhile, when an antenna is disposed in a narrow space in a mobile terminal, it is not easy to secure a sufficient space for radiation of the antenna. For example, since electromagnetic waves of a plurality of electronic components may affect the antenna, it is necessary to dispose the antenna to avoid it.

Meanwhile, radiation performance of the antenna used in a mobile terminal is frequently degraded due to a body contact of a user. Thus, a method for preventing the degradation of the antenna performance due to hand grip is required.

### DISCLOSURE

### Technical Problem

An object of the present invention is to solve the above-mentioned problems and other problems. Another object of the present disclosure provides an antenna whose radiation space may be changed.

### Technical Solution

According to an aspect of the present disclosure, there is provided a mobile terminal including: a terminal body; a main circuit board provided inside the terminal body; a main conductive member spaced apart from the main circuit board and radiating an electromagnetic wave from an end portion thereof; and a frequency varying unit provided between the main conductive member and the main circuit board and varying a resonance frequency regarding the main conductive member, wherein the frequency varying unit includes a feeding portion connected to the main circuit board; and at least one sub-conductive member disposed between the main conductive member and the feeding portion, spaced apart from each other, and fed by the feeding portion, wherein the sub-conductive member and the main conductive member are spaced apart from each other at a predetermined interval.

According to an aspect of the present disclosure, a matching module including a capacitor connected in series to the feeding portion may be connected to the feeding portion.

According to an aspect of the present disclosure, the main conductive member and the sub-conductive member may be metal members and a size of a region in which the main conductive member and the sub-conductive member overlap may be 1 to 3 mm.

According to an aspect of the present disclosure, the terminal body may include a first body occupying most of the mobile terminal and a second body detachably attached to a lower portion of the first body, wherein the second body includes: a first member exposed to a front surface of the second body; a second member exposed to a rear surface of the second body; and a connection portion connecting end portions of the first and second members.

According to an aspect of the present disclosure, the connection portion may be formed of a metal material and the main conductive member may be a part of the connection portion.

According to an aspect of the present disclosure, the first member may be formed of a non-metal material, and the main conductive member may be formed in a carrier spaced apart from the main circuit board and radiating an electromagnetic wave through the first member.

According to an aspect of the present disclosure, a resonance frequency realized by the sub-conductive members may be 4 GHz or higher.

According to an aspect of the present disclosure, the frequency varying unit may be provided in plurality, and resonance frequencies respectively realized by the plurality of frequency varying units may be different.

According to an aspect of the present disclosure, as the length of the main conductive member is reduced, the number of the sub-conductive members may be increased.

According to an aspect of the present disclosure, the matching module may further include at least one lumped element connected in series or in parallel to the capacitor.

### Advantageous Effects

The effect of the mobile terminal according to the present disclosure will be described below.

According to at least one embodiment of the present disclosure, a resonance frequency of a higher frequency band may be realized by a conductive pattern having a length of a low frequency band.

According to at least one embodiment of the present disclosure, a resonance frequency band may be varied by disposing a plurality of conductive members to be spaced apart from each other.

An additional scope of applicability of the present invention shall become obvious from the detailed description in the following. It is to be understood that both the foregoing general description and the following detailed description of the preferred embodiments of the present invention are exemplary and explanatory and are intended to provide further explanation of the invention as claimed.

### DESCRIPTION OF DRAWINGS

FIG. 1A is a block diagram illustrating a mobile terminal according to the present disclosure.

FIGS. 1B and 1C are conceptual diagrams illustrating an example of a mobile terminal according to the present disclosure, viewed in different directions, and FIGS. 1D and 1E are conceptual diagrams illustrating an example of a mobile terminal according to the present disclosure, viewed in different directions.

FIG. 2A is a view for explaining an antenna according to an embodiment of the present disclosure.

FIG. 2B is an exploded perspective view of FIG. 1C.

FIGS. 3A and 3B are diagrams for explaining a hand effect of an antenna radiation pattern according to a comparative example of the present disclosure.

FIG. 4 illustrates an example of an antenna device according to an embodiment of the present disclosure.

FIG. 5 illustrates an antenna device formed on a main circuit board according to an embodiment of the present disclosure.

FIG. 6A is a graph illustrating a resistance value according to frequency in the antenna device illustrated in FIG. 5, and FIG. 6B is a graph of a voltage standing wave ratio (VSWR) corresponding to FIG. 6A.

FIG. 7A is a view schematically illustrating an antenna device according to an embodiment of the present disclosure, FIG. 7B is a conceptual view of FIG. 7A, and FIG. 7C is a VSWR graph of the antenna device of FIG. 7A.

FIG. 8 is a conceptual diagram of an antenna device according to an embodiment of the present disclosure.

FIG. 9 is a conceptual diagram of an antenna device according to an embodiment of the present disclosure.

FIGS. 10 and 11 are conceptual diagrams of embodiments of an antenna device according to an embodiment of the present disclosure.

FIG. 12 is a partial cross-sectional view of a mobile terminal according to an embodiment of the present disclosure.

FIGS. 13A and 13B are views illustrating states in which a user grips and uses a mobile terminal.

FIGS. 14A and 14B are views for explaining an arrangement of a transmitting/receiving antenna device for wireless communication of a mobile terminal.

FIGS. 15A and 15B are conceptual diagrams of an antenna device according to an embodiment of the present disclosure.

FIGS. 16A and 16B are views for explaining a state in which an antenna device according to an embodiment of the present disclosure is applied.

FIG. 17 is a view for explaining a state in which a transmitter is formed at a lower end of a mobile terminal according to an embodiment of the present disclosure.

FIG. 18 is a view for explaining a state in which a transmitter is formed at an upper end of a mobile terminal according to an embodiment of the present disclosure.

FIG. 19 is a diagram for conceptually illustrating the mobile terminal of FIG. 18.

FIG. 20 is an entire perspective view and a partial cross-sectional view of a flexible circuit board according to an embodiment of the present disclosure.

FIG. 21 is an exploded perspective view of a flexible circuit board according to an embodiment of the present disclosure.

FIGS. 22A to 22C illustrate a configuration in which a metal material case is fed in an embodiment of the present disclosure.

FIGS. 23A and 23B are views for explaining a configuration in which a flexible circuit board is implemented in a mobile terminal according to an embodiment of the present disclosure.

### BEST MODES

Description will now be given in detail of the exemplary embodiments, with reference to the accompanying drawings. For the sake of brief description with reference to the drawings, the same or equivalent components will be provided with the same reference numbers, and description thereof will not be repeated. A suffix “module” or “unit” used for constituent elements disclosed in the following description is merely intended for easy description of the specification, and the suffix itself does not give any special meaning or function. In describing the present invention, if a detailed explanation for a related known function or construction is considered to unnecessarily divert the gist of the present disclosure, such explanation has been omitted but would be understood by those skilled in the art. The accompanying drawings are used to help easily understood the technical idea of the present invention and it should be understood that the idea of the present disclosure is not limited by the accompanying drawings. In the following description, explanations will be made in order in the clockwise direction based on the drawing in a right upper side.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

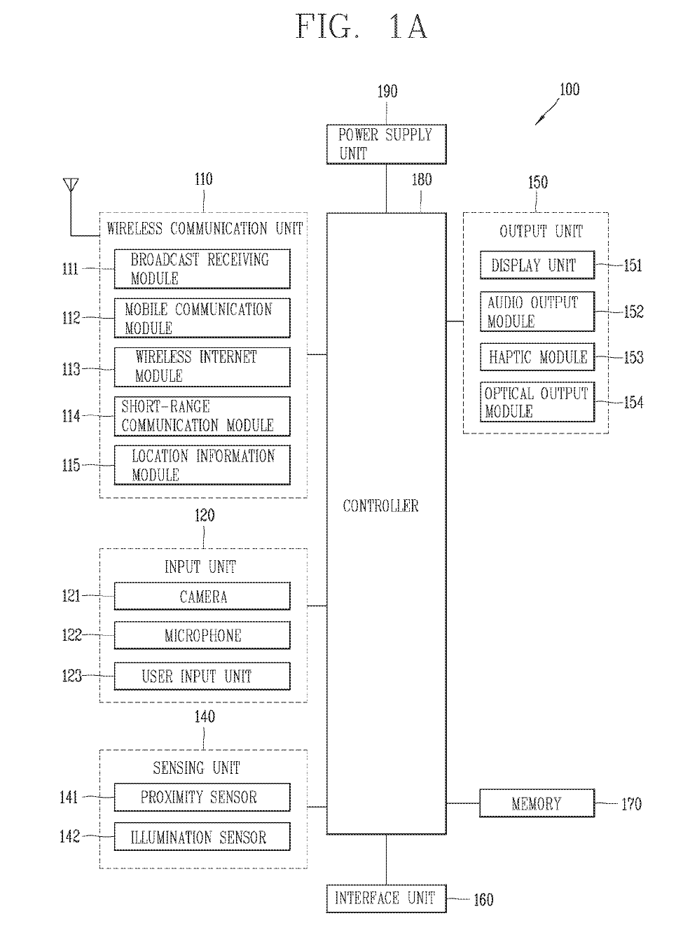

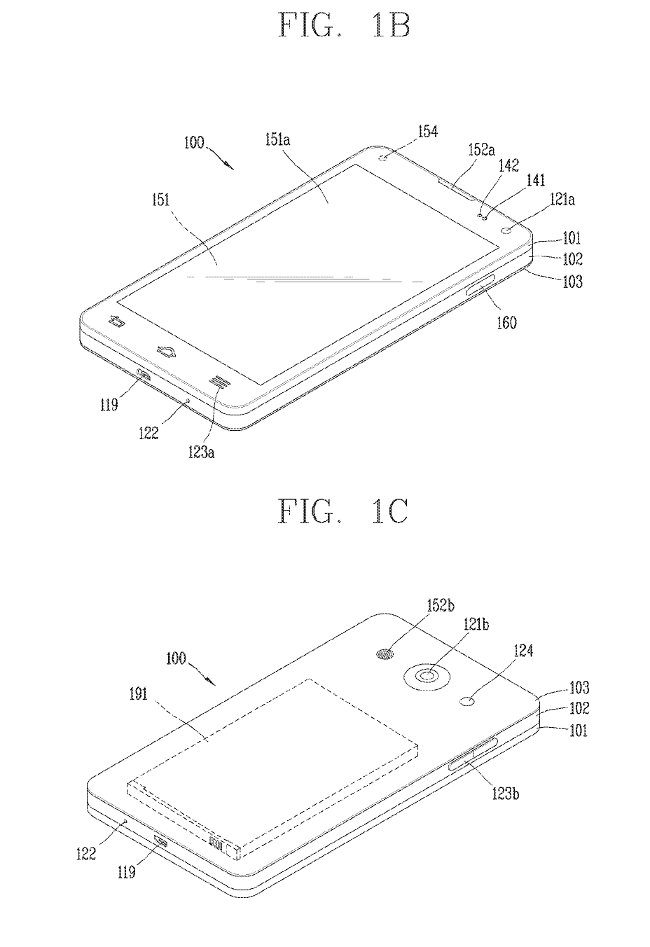

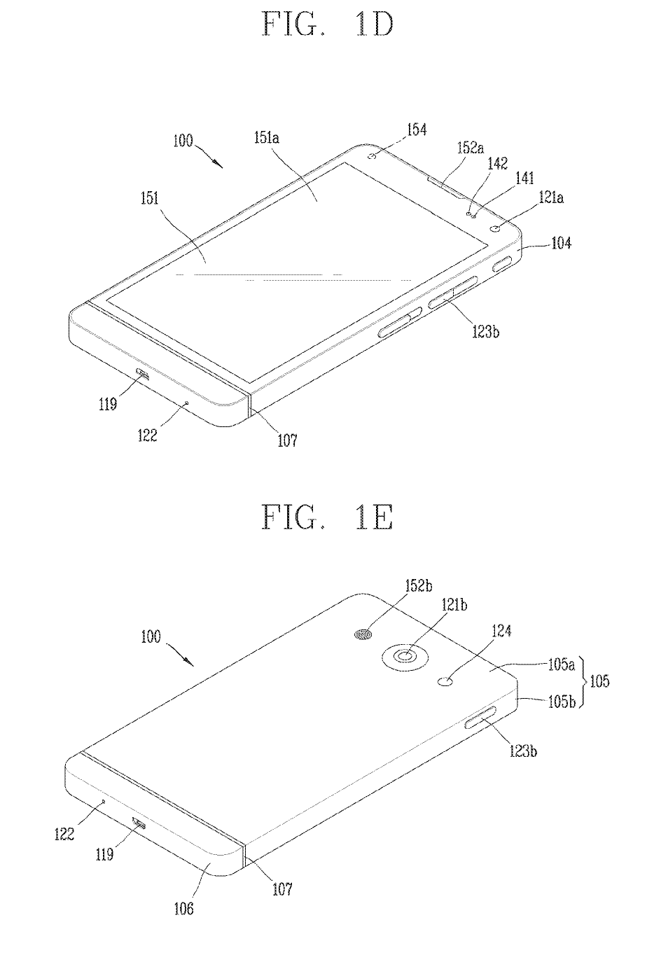

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170.

As one example, the controller 180 controls some or all of the components illustrated in FIG. 1A according to the execution of an application program that have been stored in the memory 170. In addition, the controller 180 may operate a combination of at least two of the components included in the mobile terminal 100 to drive the application program.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the above components may operate in a cooperating manner, so as to implement an operation or a control method of a glass type terminal according to various embodiments to be explained later. The operation or the control method of the glass type terminal may be implemented on the glass type terminal by driving at least one application program stored in the memory 170.

Hereinafter, referring still to FIG. 1A, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area network.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared ray proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches include a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

Here, the terminal body may be understood as a concept of referring to the mobile terminal 100 as at least one aggregate.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include the display unit 151, the first audio output module 152a, the second audio output module 152b, the proximity sensor 141, the illumination sensor 142, the optical output module 154, the first camera 121a, the second camera 121b, the first manipulation unit 123a, the second manipulation unit 123b, the microphone 122, the interface unit 160, etc.

Hereinafter, the mobile terminal 100 will be explained with reference to FIGS. 1B and 1B. The display unit 151, the first audio output module 152a, the proximity sensor 141, the illumination sensor 142, the optical output module 154, the first camera 121a and the first manipulation unit 123a are arranged on the front surface of the terminal body. The second manipulation unit 123b, the microphone 122 and the interface unit 160 are arranged on the side surfaces of the terminal body. The second audio output module 152b and the second camera 121b are arranged on the rear surface of the terminal body.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. For example, the display unit 151 may display information on an execution screen of an application program driven in the mobile terminal 100, or a User Interface (UI) or a Graphic User Interface (GUI) associated with such execution screen information.

The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output unit 152a may be implemented as a receiver for transmitting a call sound to a user's ears, and the second audio output unit 152b may be implemented as a loud speaker for outputting each type of alarm sounds or a play sound of multimedia.

It may be configured such that the sounds generated from the first audio output module 152a are released along an assembly gap between the structural bodies (e.g., between the window 151a and the front case 101). In this case, a hole independently formed to output audio sounds may not be seen or hidden in terms of appearance, thereby further simplifying the appearance of the mobile terminal 100.

The optical output module 154 can output a signal for indicating an event generation using light of a light source. Examples of events generated in the mobile terminal 100 may include message reception, call signal reception, a missed call, an alarm, a schedule notice, an email reception, information reception through an application, and the like. A signal output by the optical output module 154 may be implemented in such a manner that the mobile terminal emits monochromatic light or light with a plurality of colors. The signal output may be terminated as the mobile terminal senses that a user has checked the generated event, for example.

The first camera 121a processes image data of still pictures or video acquired by an image capture device in a video capturing mode or an image capturing mode. The processed image frames may be displayed on the display unit 151, or may be stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may be implemented in a user's non-tactile manner, e.g., by a proximity touch, a hovering touch, etc.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 10, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 (refer to FIG. 1A) may be retractable into the terminal body. Alternatively, an antenna may be formed using a film attached to an inner surface of the rear cover 103, or a case that includes a conductive material.

A power supply unit 190 (See FIG. 1A) for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

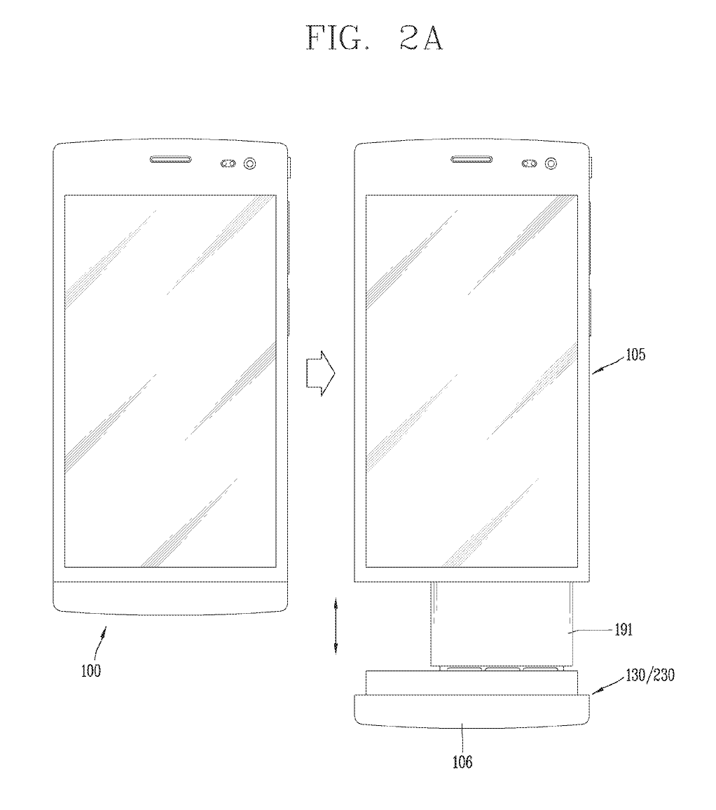

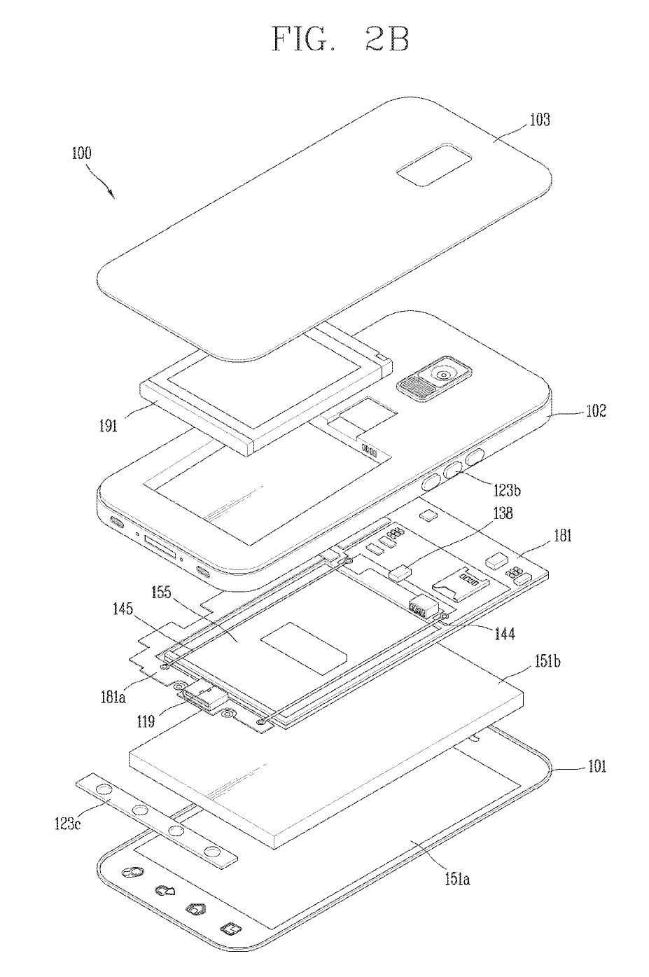

FIGS. 1D and 1E are conceptual diagrams illustrating an example of a mobile terminal according to the present disclosure, viewed in different directions, and FIG. 2A is a view for explaining an antenna related to an embodiment of the present disclosure.

Hereinafter, a mobile terminal having an antenna according to an embodiment of the present disclosure will be described with reference to FIGS. 1D, 1E, and 2A.

As illustrated in FIGS. 1D and 1E, in an embodiment of the present disclosure, the case is illustrated as a uni-body. However, the present disclosure is not limited thereto and, as illustrated in FIGS. 1B and 1C, the appearance of the mobile terminal may be formed by the front case 101, the rear case 102, and the rear cover 103.

Hereinafter, a unibody type terminal will be mainly described. However, the present disclosure is not limited thereto and may also be applied to the terminal illustrated in FIGS. 1B and 1C unless otherwise specifically mentioned.

In an embodiment of the present disclosure, in order to replace the battery 161 supplying power to the mobile terminal, a second body 106 may be inserted into or withdrawn from a first body 105 of the mobile terminal. That is, as illustrated in FIG. 2A, the mobile terminal 100 according to an embodiment of the present disclosure may be configured such that the second body 106 capable of receiving the battery 191 is inserted into the lower end of the mobile terminal 100 or drawn out from the lower end of the mobile terminal 100.

The mobile terminal according to one embodiment of the present disclosure includes the display unit 151 having a window 151a, the first body 105 in which the display unit 151 is mounted to form an internal space between the display unit 151 and the first body 105, and the second body 106 to which the battery 191 is selectively connected. The second body 106 may be inserted into or drawn out from the lower end of the first body 105 to be inserted into the internal space to implement a first state and to be drawn out from the internal space to implement a second state. Various electronic components may be provided in the internal space and a metal material intermediate frame may be provided to ensure rigidity.

In an embodiment of the present disclosure, the display unit 151 disposed to face a front side of the terminal 100 and the first body 105 covering the rear surface of the display unit 151 to form the internal space form an appearance of the mobile terminal 100 and an appearance of the lower end of the mobile terminal is formed by the second body 106.

In the second state, the battery 191 is separated from the first body 105. When the battery 191 is separated, power of the mobile terminal is turned off.

Meanwhile, an antenna device 230/230 may be formed at an upper or lower end of the mobile terminal. In addition, the antenna device 230/230 may be provided in plurality and disposed at each end of the terminal, and each antenna may be configured to transmit and receive wireless signals of different frequency bands.

In addition, the mobile terminal 100 according to an embodiment of the present disclosure may include an intermediate frame (not shown) formed of a metal material. The intermediate frame may be formed of a metal material to maintain sufficient rigidity although the intermediate frame is formed to have a small thickness. The intermediate frame may operate as a ground. That is, a main circuit board 181 or the antenna device 230/230 may be grounded to the intermediate frame, and the intermediate frame may operate as a ground of the main circuit board 181 or the antenna device 230/230. In this case, the intermediate frame may extend the ground of the mobile terminal 100. Therefore, it is assumed that the ground hereinafter refers to at least one of the intermediate frame and the main circuit board 181.

The main circuit board 181 may be electrically connected to the antenna device 230/230 and process wireless signals (or radio electromagnetic waves) transmitted and received by the antenna. In order to process the wireless signal, a plurality of transceiver circuits may be formed or mounted on the main circuit board 181.

The transceiver circuits may include one or more integrated circuits and related electrical components. For example, each transceiver circuit may include a transmission integrated circuit, a reception integrated circuit, a switching circuit, an amplifier, and the like.

The plurality of transceiver circuits simultaneously feed conductive members, which are radiators, so that the plurality of antenna devices 230/230 may operate simultaneously. For example, while any one of the plurality of antenna devices is transmitting a signal, the other may receive a signal, and both may transmit or receive signals.

FIG. 2B is an exploded perspective view of FIG. 10.

Referring to FIG. 2B, the mobile terminal includes the window 151a and the display module 151b that constitute the display unit 151. The window 151a may be coupled to one surface of the front case 201.

A frame 155 is formed to support electrical elements between the front case 201 and the rear case 102. The frame 155, which is a support structure inside the terminal, may support at least one of the display module 151b, the camera module 121, the antenna device, the battery 191, or the circuit board 181.

A portion of the frame 155 may be exposed to the outside of the terminal. In addition, the frame 155 may form a part of a sliding module that connects the main body and the display unit in a slide type terminal, not a bar type terminal.

FIG. 2B shows an example in which the circuit board 181 is disposed between the frame 155 and the rear case 102 and the display module 151b is coupled to one surface of the frame 155. The circuit board 181 and the battery 191 are disposed on the other surface of the frame 155 and the battery case 103 may be coupled to the rear case 102 to cover the battery 191.

The window 151a is coupled to one surface of the front case 201. A touch sensor (not shown) may be mounted on the window 151a. The touch sensor may be formed to sense a touch input and formed to be light-transmissive. The touch sensor may be mounted on a front surface of the window 151a and may be configured to convert a change in voltage, or the like that occurs in a specific portion of the window 151a into an electrical input signal.

The display module 151b is mounted on a rear surface of the window 151a. In this embodiment, a thin film transistor-liquid crystal display (TFT LCD) is disclosed for example of the display module 151b, but the present disclosure is not limited thereto.

For example, the display module 151b may be a liquid crystal display (LCD), an organic light emitting diode (OLED), a flexible display, a 3D display, and the like.

As described above, the circuit board 181 may be formed on one side of the frame 155 or may be mounted on a lower side of the display module 151b. At least one electronic element is mounted on a lower surface of the circuit board 181.

A recessed receiving portion is formed in the frame 155 to receive the battery 191. A contact terminal connected to the circuit board 181 may be formed on one side of the battery receiving portion for the battery 191 to supply power to the terminal body.

An antenna device 130 may be formed at an upper portion or a lower portion of the mobile terminal. An antenna provided at the upper portion of the mobile terminal may be referred to as an upper antenna 130a, and an antenna provided at the lower portion thereof may be referred to as a lower antenna 130b. Also, a plurality of antenna devices 130 may be disposed at each end portion of the terminal, and each antenna device may be configured to transmit and receive wireless signals of different frequency bands.

The frame 155 may be formed of a metal material to maintain sufficient rigidity although the frame 155 is formed to have a small thickness. The metal frame 155 may operate as a ground. That is, the circuit board 181 or the antenna device may be grounded to the frame 155, and the frame 155 may operate as a ground of the circuit board 181 or the antenna device. In this case, the frame 155 may extend a ground of the mobile terminal.

The circuit board 181 is electrically connected to the antenna device, and is configured to process wireless signals (or radio electromagnetic waves) transmitted and received by the antenna device. In order to process a wireless signal, a plurality of transceiver circuits 138 may be formed or mounted on the circuit board 181.

The transceiver circuits may include one or more integrated circuits (ICs) and related electrical elements. In an example, the transceiver circuits may include a transmission IC, a reception IC, a switching circuit, an amplifier, and the like, and may be termed a radio frequency integrated circuit (RFIC).

The plurality of transceiver circuits may simultaneously feed conductive members that are radiators, so that a plurality of antenna devices may operate simultaneously. For example, while any one of the plurality of antenna devices is transmitting a signal, the other may receive a signal, and both may transmit signals or both receive signals.

In addition, the RFIC 138 may be configured to implement a control algorithm that controls the use of the antenna in the antenna device. For example, in order to support an antenna diversity scheme and a MIMO scheme or other multi-antenna schemes, the RFIC 138 may a perform signal quality monitoring operation, a sensor monitoring operation, and other data collecting operations and control which antenna structure is used to receive and process data according to collected data. For example, the RFIC 138 may control which of two or more antennas is to be used for receiving an incoming RF signal, control which of the two or more antennas is to be used for transmitting an RF signal, control routing data streams in parallel through two or more antennas, and the like.

In performing this control operation, the RFIC 138 may open and close a switch, turn on or off a receiver and a transmitter, adjust an impedance matching circuit, and configure a switch (e.g., a filtering and switching circuit used for impedance matching and signal routing) in a front-end module (FEM) interposed between the RF transceiver circuit and the antenna structure and an RF circuit.

Coaxial cables 144 and 145 connect the circuit board 181 and each antenna device. In an example, the coaxial cables 144 and 145 may be connected to feeding devices that feeds the antenna devices. The feeding devices may be formed on one surface of a flexible circuit board 181a formed to process signals input from an operating unit 123a. The other surface of the flexible circuit board 181a may be coupled to a signal transmission unit 123c formed to transmit a signal from an operating unit 217. In this case, a dome may be formed on the other surface of the flexible circuit board 181a, and an actuator may be formed in the signal transmission unit 123c.

An embodiment of the present disclosure is to solve the problem that quality of wireless communication is degraded by the user's body. Hereinafter, contents of improving a hand grip issue that occurs when the user grips the mobile terminal 100 by the hand will be disclosed.

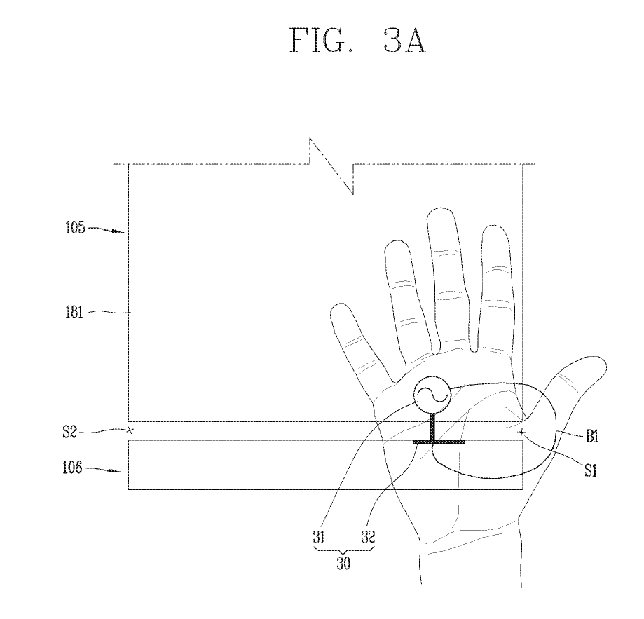

FIGS. 3A and 3B are views for explaining a hand effect of an antenna radiation pattern according to a comparative example of the present disclosure.

FIGS. 3A and 3B illustrate antenna radiation patterns B1 and B2 radiated from an antenna device 30 formed between the first body 105 that occupies most of the mobile terminal 100 and a second body 105 which is provided below the first body 105 and detachable to the first body 105. That is FIG. 3A is a view for explaining a hand effect due to a user's body in case where a conductive member 32 of the antenna device 130 is disposed in a region which overlaps the user's body when the user grips the mobile terminal 100. Here, the first body 105 may be termed a main body, and the second body 106, which is a part detachably attached to the first body 105 and engaged with a part of the first body 105, may be termed a lower cap. FIGS. 3A and 3B illustrate a grip state when the user uses the mobile terminal 100. In FIGS. 3A and 3B, the right side of the mobile terminal 100 is gripped. If the left side of the mobile terminal 100 is gripped, it does not affect radiation of the antenna device 130, so there is no problem. The hand effect refers to a case where radiation of the antenna device 30 built in the mobile terminal 100 is not properly performed due to a part of the body including the user's hand.

FIG. 3A shows a case where radiation of the antenna device 130 is not performed properly and antenna performance is affected. Referring to FIG. 3A, the antenna device 30 is formed in the first body 105 and the second body 106, and the antenna device 130 includes a feeding portion 31 and a conductive pattern 32.

The antenna device 130 radiates an electromagnetic wave through a slot 51 formed between the first body 105 and the second body 106. Since the conductive pattern of the antenna device 130 is formed adjacent to the right side slot 51, the electromagnetic wave is radiated through the right side slot 51. A radiation pattern B1 here is illustrated in FIG. 3A.

Since the user's body is positioned adjacent to the slot 51 formed on the right side among the slots, radiation of the antenna is affected. In general, a radiator in the antenna radiates by avoiding a part formed of a metal material so that electromagnetic waves are radiated to the outside. Particularly, when a part of the case forming the appearance of the mobile terminal 100 is formed of a metal material, an electromagnetic wave is radiated to the outside through a part formed of a nonmetallic member. FIG. 3A is a diagram illustrating that radiation performance of an antenna which radiates an electromagnetic wave through a nonmetal member, e.g., a slot portion, is hindered by the user's body.

In FIGS. 3A and 3B, it may also be applied to the mobile terminal 100 in which the first body 105 and the second body 106 are not differentiated from each other, as well as to a scheme in which the first body 105 and the second body 106 are detachably attached. For example, it may also be applied to the mobile terminal 100 in which a part of the user's body is positioned in a region hindering radiation of the antenna device 30 in the configuration (See FIGS. 1B and 1C) in which the first body 105 and the second body 106 are integrated.

FIG. 3B illustrates a method of solving the hand effect problem by forming a radiation position (or region) as a region not hindered by the user's body. More specifically, the conductive member 32 extends from the right side to the left side to allow electromagnetic waves to be radiated through the left slot S2, unlike the case illustrated in FIG. 3A in which an electromagnetic wave is radiated through the right slot S1.

As illustrated in FIG. 3B, since radiation from the antenna device 130 is made at the end of the conductive pattern 32, a hand effect by the user's body may be reduced. In this case, a radiation pattern B2 of the antenna device 30 based on the conductive pattern 32 is like that illustrated in FIG. 3B. As illustrated in FIG. 3B, the user's body surrounds the right side slot S1 and, since the radiation pattern B2 of the antenna device 130 is formed toward the left side slot S2, the antenna device 30 may radiate an electromagnetic wave, while being rarely affected by the user's body.

As described above, in order to change a radiation position (or region), a length of the conductive pattern 32 must be long. If the length of the conductive pattern 32 changes, a resonant frequency varies. That is, since the length of the conductive pattern 32 in FIG. 3B is longer than that in FIG. 3A, a resonance frequency in FIG. 3B is lower than a resonance frequency of the antenna device 30 in FIG. 3A, and thus, if the length of the conductive pattern 32 is merely increased, a resonance frequency desired to be implemented may not be realized properly.

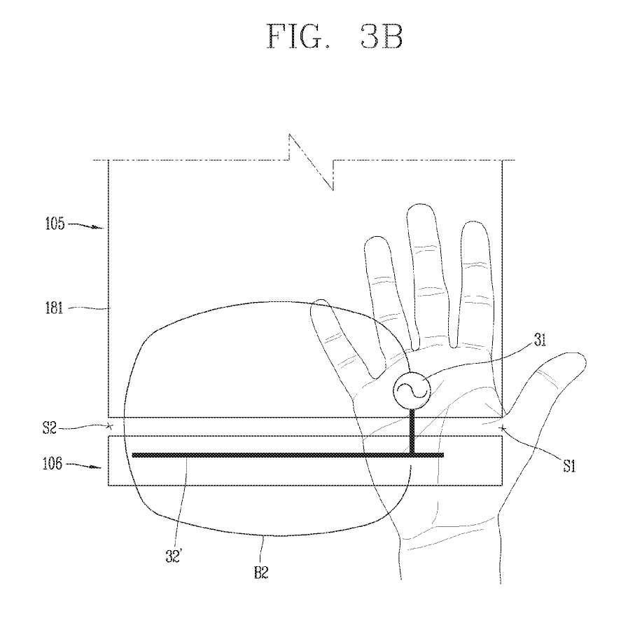

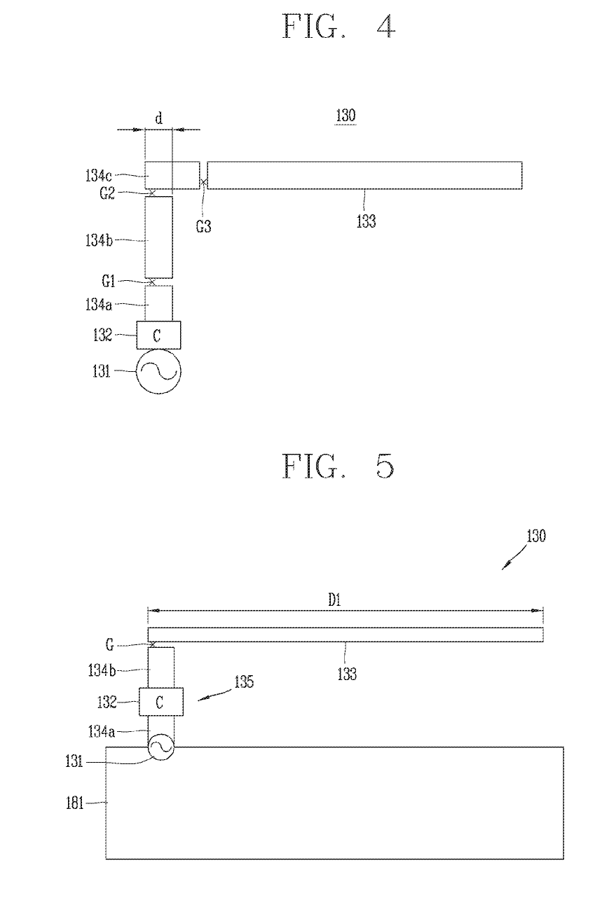

FIG. 4 illustrates an example of an antenna device 130 according to an embodiment of the present disclosure, and FIG. 5 illustrates an antenna device 130 formed on the main circuit board 181 according to an embodiment of the present disclosure.

Referring to FIGS. 4 and 5, the mobile terminal 100 according to an embodiment of the present disclosure includes a first body 105, a main circuit board (not shown) provided inside the first body 105, a main conductive member 133 which is spaced apart from the main circuit board 181 and radiates electromagnetic waves from an end portion (or a terminating end) thereof, and a frequency varying unit 135 provided between the main conductive member 133 and the main circuit board 181 and varying a resonance frequency with respect to the main conductive member 133.

Hereinafter, the resonance frequency regarding the main conductive member 133 varied by the frequency varying unit 135 will be described in more detail. When a total length of a conductive member in a state in which the entire conductive members (including the main conductive member 133 and sub-conductive members 134a and 134b) is integrally formed in the antenna device 130 including the main conductive member 133 is L, a resonance frequency in the state in which the entire conductive members are integrally formed is H1, and a resonance frequency of the antenna device 130 in a state of being varied by the frequency varying unit 135 is H2, H1 is smaller than H2 (H1<H2).

In other words, if the same conductive member is divided and disposed separately, a resonance frequency thereof is higher than a resonance frequency in a state in which the conductive members are integrally formed.

For example, in the case of a planar inverted F antenna (PIFA), the center resonance frequency of a frequency band may be changed from /4 to. In other words, a physically small antenna (/4) having a high resonance frequency is converted into a physically large antenna ( ).

This is also the same with a case where the same main conductive member 133 is used as a radiator and the frequency varying unit 135 connected to the main conductive member 133 is configured to be different.

For example, when the resonance frequency for the main conductive member 133 is 700 MHz, the resonance frequency of the antenna device 130 may be 2.0 GHz by adding the frequency varying unit 135. In this manner, the resonance frequency higher than the resonance frequency, which may be realized by the original length of the main conductive member 133, may be realized without changing the length of the main conductive member 133.

Here, varying the resonance frequency includes not only a change in the resonance frequency with respect to the main conductive member 133 but also a change in the resonance frequency of the antenna device 130 itself. This is because the main conductive member 133 is a component of the antenna device 130. Therefore, a change in the resonance frequency in the embodiment of the present disclosure means both a change in the resonance frequency only by the main conductive member 133 and a change in the resonance frequency of the antenna device 130 itself.

The main conductive member 133 is a conductive member forming the antenna device 130 and the frequency varying unit 135 varies the resonant frequency realized by the main conductive member 133, which performs a function of lowering or raising the resonance frequency. In an embodiment of the present disclosure, raising of the resonance frequency will be described.

However, the present disclosure is not limited thereto, and the resonance frequency may be lowered, while the length of the main conductive member 133 is maintained. For example, the frequency varying unit 135 includes a lumped element and may perform a function of lowering the resonance frequency by the combination of the lumped elements.

The frequency varying unit 135 includes a feeding portion 131 connected to the main circuit board 181 and at least one sub-conductive member 134 formed between the main conductive member 133 and the feeding portion 131, spaced apart from each other, and fed by the feeding portion 131. The feeding portion 131 may be formed on the main circuit board 181 or may be formed by a contact terminal such as a C-clip or a fastening member such as a screw.

The sub-conductive member 134 and the main conductive member 133 are spaced apart from each other at a predetermined interval. When a single sub-conductive member 134 is provided, the sub-conductive member 134 is spaced apart from the main conductive member 133. In this manner, in an embodiment of the present disclosure, by disposing the sub-conductive members 134 to be spaced apart from each other, the resonance frequency implemented in the main conductive member 133, further in the antenna device 130, may be raised. More specifically, in order to lower the resonance frequency in the antenna device 130, the length of the conductive member must be lengthened, and in order to raise the resonance frequency, the length of the conductive member must be shortened. However, in the embodiment of the present disclosure, the frequency varying unit 135 is introduced to realize a high resonance frequency using the conductive member having a length corresponding to a low resonance frequency. The resonance frequency may be increased by the frequency varying unit, while maintaining the length of the main conductive member 133.

That is, in an embodiment of the present disclosure, a plurality of conductive members 133 and 134 disposed in a predetermined direction and fed from the main circuit board 181 are provided.

In an embodiment of the present disclosure, the sub-conductive members 134 are spaced apart from each other by a predetermined interval to increase the resonance frequency realized by the main conductive member 133 and the sub-conductive members 134. The main conductive member 133 and the sub-conductive members 134 will be collectively referred to as a conductive pattern or a conductive member. That is, the antenna device 130 radiates an electromagnetic wave by means of the conductive pattern.

Here, a matching module 132 including a capacitor connected in series to the feeding portion 131 may be connected to the feeding portion 131, and here, the matching module 132 includes the capacitor connected in series to the feeding portion 131in order to increase the resonance frequency based on the conductive pattern. The matching module may be configured by a combination of lumped elements, and thus, it may include at least one inductor and at least one capacitor and may include a combination of a plurality of lumped elements in series or in parallel. The matching module 132 is a general component in the art to which the present disclosure pertains, and thus, a detailed description thereof will be omitted.

However, in an embodiment of the present disclosure, since the matching module 132 serves to realize a resonance frequency higher than a resonance frequency Hm that may be implemented by only the main conductive member 133, the matching module 132 must include a capacitor connected in series to the feeding portion 131. Here, the capacitor is an electronic component having a predetermined permittivity, but by simply disposing the sub-conductive members 134 to be spaced apart from each other, an objective to be achieved by the matching module 132 may be achieved.

In an embodiment of the present disclosure, the plurality of conductive members may be formed of a metal material and may be, for example, a copper wire or a copper strip or may be a flexible printed circuit board (FPCB). Here, an overlap region d of the conductive members refers to the widths of the conductive members facing each other. The size of the overlap region d of the conductive members is limited to 1 to 3 mm.

In an embodiment of the present disclosure, in order to increase the resonance frequency to be higher than the resonance frequency Hm regarding the main conductive member 133 by the plurality of conductive members, the conductive members are electrically disconnected. The electrical disconnection here refers to that flow of a current between adjacent conductive members 133, 134a, 134b is weakened, rather than that electrical flow between neighboring conductive members 133, 134a, and 134b is completely disconnected, which is different from electrical isolation.

That is, the conductive members 133, 134a and 134b in the embodiment of the present disclosure are physically disconnected, so that current flow is not smooth between the conductive members 133, 134a and 134b but current minutely flows to operate the antenna device 130. Meanwhile, electrical isolation refers to a state in which current is substantially interrupted so that it cannot operate the antenna device 130.

The electrically disconnected state between the conductive members 133, 134a, and 134b is different from general coupling feeding. In general, coupling feeding takes place between the conductive members which are spaced apart from each other. One of the conductive members is directly fed and the other conductive member, which is spaced apart from the directly fed conductive member by a predetermined interval, is indirectly fed by an electrical field formed around the conductive member.

If the above-mentioned general type coupling feeding is referred to as narrow coupling feeding, the feeding form between the conductive members 133, 134a and 134b in the embodiment of the present disclosure may be broad coupling feeding. This is because, since electrical flow is present between the sub-conductive members 134a and 134b or between the sub-conductive member 134b and the main conductive member 133 in a separated state, it may be considered to be broad coupling feeding.

Thus, hereinafter, a feeding method between the conductive members in the embodiment of the present disclosure will be referred to as a broad coupling feeding method, and a method based on general coupling feeding will be referred to as a narrow coupling feeding method.

When narrow coupling feeding takes place between a longer conductive member and a shorter conductive member, a length of the shorter conductive member is generally greater than ½ of a length of the longer conductive member. However, in an embodiment of the present disclosure, broad coupling feeding, rather than narrow coupling feeding, is performed between the conductive members 133, 134a, and 134b so that the conductive members 133, 134a, and 134b are electrically disconnected in a low band, and thus, a resonance frequency corresponding to the low band is not generated and only a resonance frequency corresponding to a high band or a middle band is generated.

Here, since the frequency varying unit 135 is unnecessary for the low band, it is unrelated to the present disclosure. That is, an embodiment of the present disclosure relates to realization of a resonance frequency of a high band, while the main conductive member 133 having a length corresponding a low band is maintained.

If the size of the overlap region d between the conductive members 133, 134a, and 134b is greater than 3 mm, narrow coupling feeding may take place, and when the size of the overlap region d is smaller than 1 mm, the adjacent conductive members 133, 134a, and 134b may be electrically insulated and broad coupling feeding may not be performed. Therefore, in an embodiment of the present disclosure, the size of the overlap region between the conductive members 133, 134a, 134b is limited to 1 to 3 mm. However, the present disclosure is not limited thereto, and a size by which narrow coupling feeding does not occur and the conductive members are not completely insulated may be within the scope of the present disclosure.

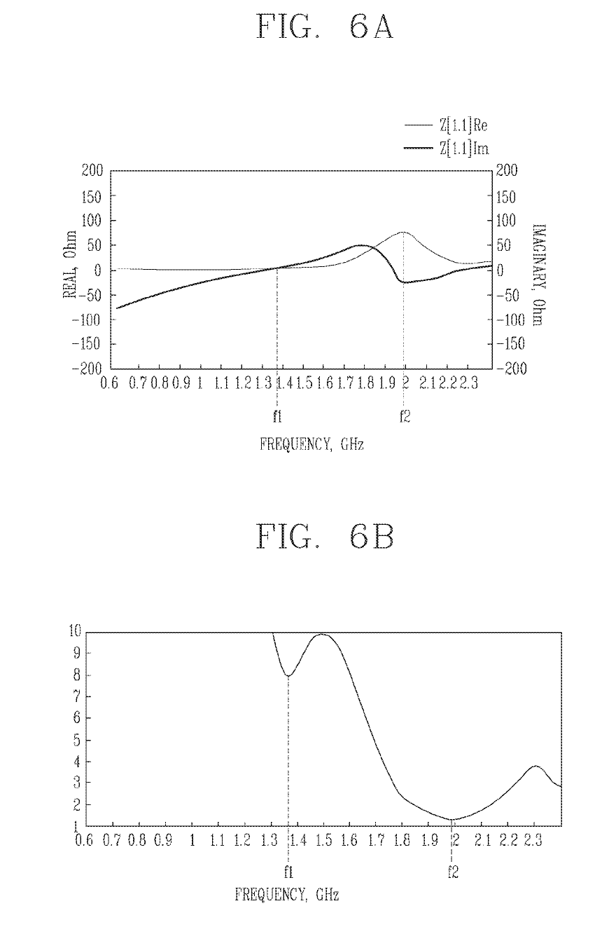

FIG. 6A is a graph illustrating a resistance value according to frequencies of a real number component and an imaginary number component in the antenna device 130 illustrated in FIG. 5, and FIG. 6B is a voltage standing wave ratio (VSWR) graph corresponding to FIG. 6A. The real number component refers to a real number part of impedance and the imaginary number component refers to reactance as an imaginary number part of impedance.

Referring to FIGS. 6A and 6B, it can be seen that resonance does not occur when a value of the imaginary number component is less than 0 along a high-frequency band from a low-frequency band and this is because resonance in the low-frequency band is blocked. That is, resonance does not occur in the low frequency band by the frequency varying unit.

Resonance is generated for the first time at a frequency f1, at which the imaginary number component is 0, and a resonance frequency of a high band desired to be implemented occurs at a frequency f2 at which the real number part is maximized and the imaginary number part is minimized.

Meanwhile, in an embodiment of the present disclosure, as illustrated in FIG. 1E, the first body 105 includes a rear surface 105a and a side surface 105b formed to extend from an end portion of the rear surface 105a toward a front surface and is formed of a metal material so that the main conductive member 133 is a part of the side surface 105a. For example, a part of the case forming an appearance may be formed of a metal material so that it may become a part of the main conductive member 133 of the antenna device 130. Here, a part of the case does not necessarily have to be the side surface 105a, and may be a part of the front surface or the rear surface of the case. Particularly, since many electronic components are disposed on the rear surface of the mobile terminal 100, when the front surface of the mobile terminal 100 is formed of a metal material, the front surface may serve as a radiator of the antenna. However, when the case includes a slit, the conductive member is limited by the slit. Here, the case includes the first body 105 and the second body 106.

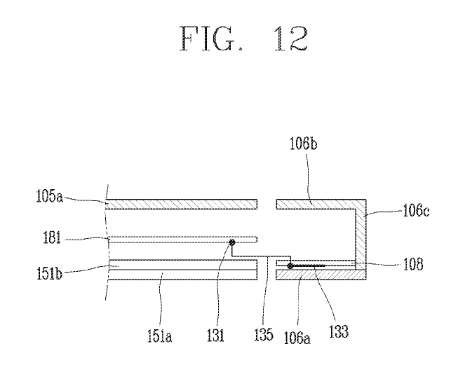

FIG. 12 is a partial cross-sectional view of a mobile terminal 100 according to an embodiment of the present disclosure. Referring to FIG. 12, the cross-section of the second body 106 has a substantially ‘⊏’ or ‘C’ shape, and the second body 106 includes a first member 106a exposed to the front surface of the second body 106, a second member 106b exposed to the rear surface of the second body 106, and a connection portion 106c connecting end portions of the first and second members 106a and 106b. In this manner, since the second body 106 has a cap shape and at least a part thereof includes a metal material, the second body 106 may operate as a radiator of the antenna device 130.

In an embodiment of the present disclosure, the second body 106 including the first member 106a may be entirely formed of a metal material, or the second member 106b and the connection portion 106c may be formed of a metal material, while the first member 106a may be formed of a non-metallic material.

When the first member 106a is a non-metallic member, the conductive member 133 may be provided on one surface of the carrier 108, which is separated from the main circuit board 181 and provided in the second body 106. In this case, radiation through the conductive member 133 is made through the first member 106a.

When the side surface of the case is formed of a metal material member, the main conductive member 133 may form a part of the side surface, and an electromagnetic wave may be radiated through the connection portion 106c of the second body 106.

In an embodiment of the present disclosure, the resonant frequency implemented by the plurality of conductive members 133, 134a, 134b is raised. Here, if the resonance frequency implemented by the frequency varying unit 135, more specifically, by the sub-conductive members 134a and 134b, is included in the resonance frequency band desired to be implemented, the main conductive member 133 may be unnecessary. In an embodiment of the present disclosure, in order to prevent this, the resonance frequency implemented by the sub-conductive members 134a and 134b is set to be 4 GHz or higher. To this end, in an embodiment of the present disclosure, a total length of the sub-conductive members 134a and 134b is set to about 7 to 8 mm.

As described above, by sufficiently increasing the resonant frequency of the sub-conductive members 134a and 134b, it is not possible to realize the resonant frequency to be implemented by only the sub-conductive members 134a and 134b. In this case, the resonance frequency to be implemented is generally 700 to 25,000 MHz.

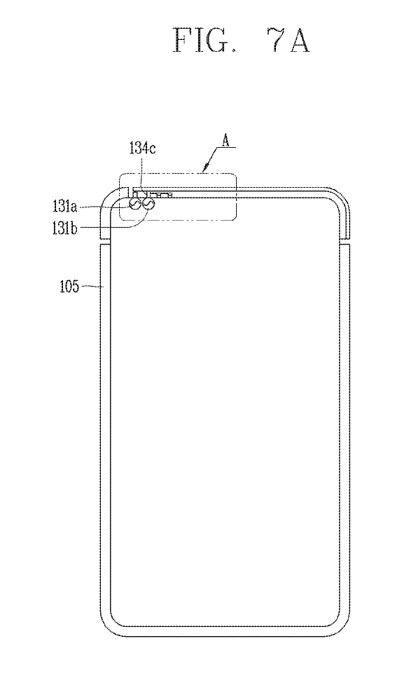

FIG. 7A is a schematic view of an antenna device 130 according to an embodiment of the present disclosure, FIG. 7B is a conceptual view of FIG. 7A, and FIG. 7C is a VSWR graph of the antenna device 130 of FIG. 7A.

Referring to FIGS. 7A and 7B, the main conductive member 133 of the antenna device 130 forms an appearance of the mobile terminal 100 and includes a side surface portion formed of a metal material. In FIGS. 7A and 7B, it can be seen that a feeding portion 131b is added, unlike FIG. 5. That is, the frequency varying unit 135d is added.

In FIGS. 7A and 7B, the first frequency varying unit 135a is provided in the main conductive member 133 and the second frequency varying unit 135b is spaced apart from the first frequency varying unit 135a and connected thereto. The first frequency varying unit 135a includes a first feeding portion 131a, one or more sub-conductive members 134a and 134b, and a first matching module 132a, like the frequency varying unit 135 in FIG. 5. Meanwhile, the second frequency varying unit 135b includes a second feeding portion 131b, a second sub-conductive member 134c integrally formed with the main conductive member 133, and matching modules 132b′ and 132b″ connected in parallel to the second sub-conductive member 134c.

As illustrated in FIG. 7C, resonance frequencies f1 and f2 in a low band are realized and resonance frequencies f3 and f4 in a high band are implemented in the antenna device illustrated in FIGS. 7A and 7B. More specifically, resonance frequencies f1 and f2 of the low band are realized by the second frequency varying unit 135b and the resonance frequencies f3 and f4 of the high band are realized by the first frequency varying unit 135a. In FIG. 7C, the thick solid line is a VSWR graph based on the second frequency varying unit 135b, and the thin solid line is a VSWR graph based on the first frequency varying unit 135a.

FIG. 8 is a conceptual diagram of the antenna device 130 according to an embodiment of the present disclosure. Referring to FIG. 8, in an embodiment of the present disclosure, in order to implement a plurality of frequency bands, one or more frequency varying units 135a, 135b, and 135c are provided between the main conductive member 133 and the main circuit board 181. That is, the frequency varying units 135a, 135b, and 135c may be provided in plurality and have the same or similar configuration.

That is, the first frequency varying unit 135a is the same as the frequency varying unit 135 described above with reference to FIG. 5. The second frequency varying unit 135b includes a second feeding portion 131b connected to the main circuit board 181 and one or more second sub-conductive members 134a″ and 134b″ fed by the second feeding portion 131b and spaced apart from each other. Further, the second sub-conductive members 134a″ and 134b″ are disposed to be spaced apart from the main conductive member 133. In this manner, the second frequency varying unit 135b is similar in configuration and function to the first frequency varying unit 135a.

The second frequency varying unit 135b may include a second matching module 132b including a capacitor provided between the second feeding portion 131b and the main circuit board 181 and connected in series to the second feeding portion 131b.

In addition, a frequency varying unit may be further provided. That is, in the case of including a third frequency varying unit 135c, the third frequency varying unit 135c includes a third feeding portion 131c connected to the main circuit board 181 and one or more third sub-conductive members 134a′″ and 134b′″ fed by the third feeding portion 131c and spaced apart from each other. In addition, the third sub-conductive members 134a′″ and 134b′″ are spaced apart from the main conductive member 133. Also, in this case, the third frequency varying unit 135c may further include a third matching module 132c including a capacitor provided between the third feeding portion 131c and the main circuit board 181 and connected in series to the third feeding portion 131c.

Meanwhile, when there are a plurality of frequency varying units, a resonance frequency to be implemented may be varied according to positions formed at the main conductive member 133. For example, in order to realize a high resonance frequency, the frequency varying unit may be disposed at a position closer to one end portion of the main conductive member 133 and away from the first frequency varying unit 135a. In other words, the resonance frequency to be implemented may be adjusted according to distances from each of the feeding portions 131a, 131b, and 131c to a radiation end portion of the main conductive member 133.

Further, in an embodiment of the present disclosure, since the resonance frequency may be implemented according to the combination of the first to third frequency varying units 135a, 135b and 135c, the resonance frequency of the antenna device 130 may not be determined only by a position at which the first to third frequency varying units 135a, 135b, and 135c are connected to the main conductive member 133 but may be determined also by the configuration of the first to third frequency varying units 135a, 135b, and 135c. In other words, depending on how the first to third frequency varying units 135a, 135b and 135c are configured, it is possible to realize a high resonance frequency or a low resonance frequency, irrespective of the connection position with the main conductive member 133.

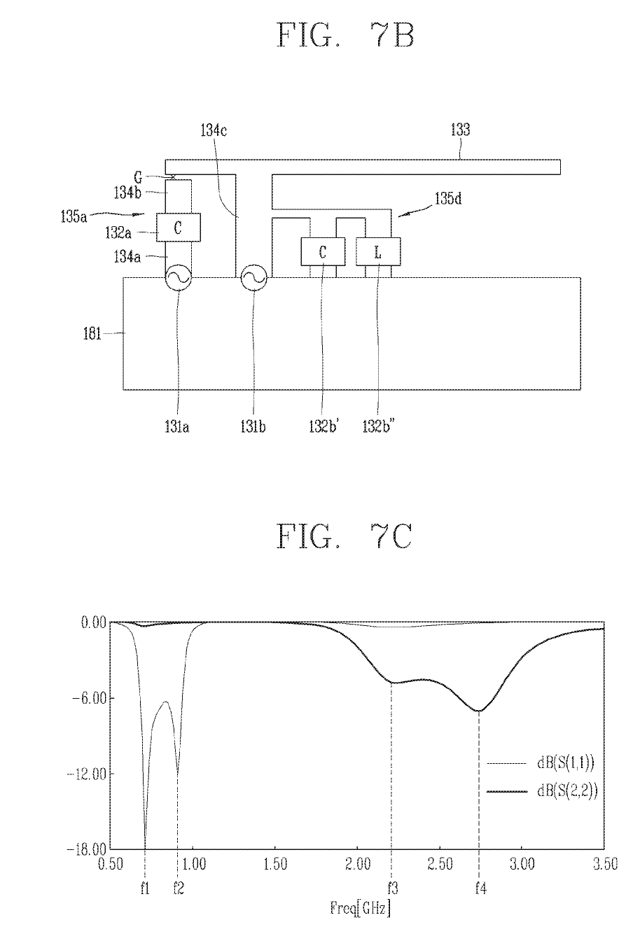

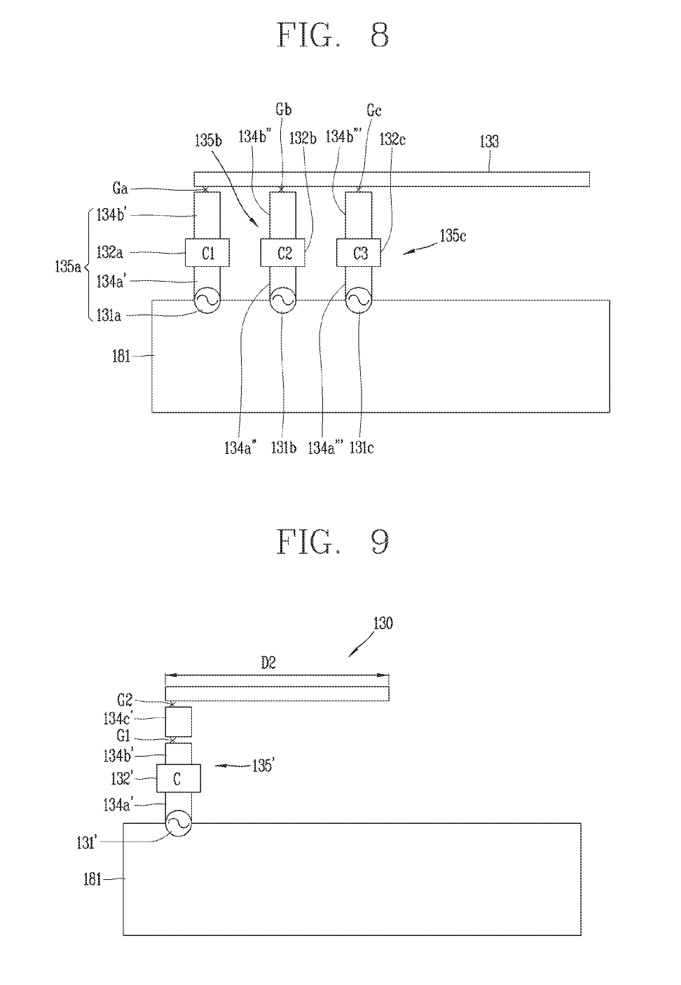

FIG. 9 is a conceptual view of an antenna device 130 according to an embodiment of the present disclosure. The main conductive member 133 in FIG. 9 is formed to be shorter than the main conductive member 133 in FIG. 5. The resonance frequencies implemented by the antenna device 130 of FIGS. 5 and 9 are the same, and to this end, it can be seen that the number of the sub-conductive members 134a′, 134b′, and 134c′ is increased in FIG. 9. That is, as the length of the main conductive member 133 is reduced, the number of the sub-conductive members 134a′, 134b′, and 134c′ must be increased. Thus, the length of the main conductive member 133 and the number of the sub-conductive members 134a′, 134b′, and 134c′ are mutually complementary. In other words, if the length of the main conductive member 133 is to be reduced, the number of the sub-conductive members 134a′, 134b′, and 134c′ must be increased.

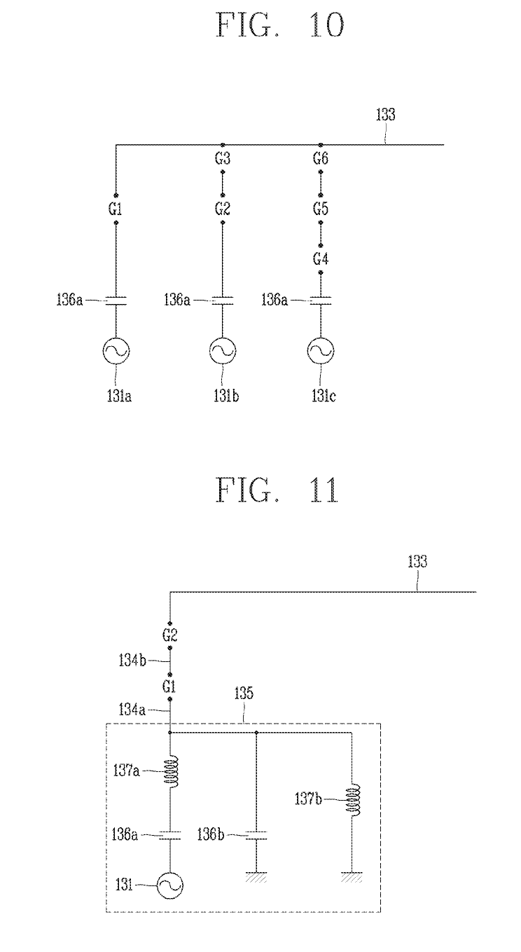

FIGS. 10 and 11 are conceptual diagrams of embodiments of the antenna device 130 according to an embodiment of the present disclosure.

First, referring to FIG. 10, the main conductive member 133 is fed by the first feeding portion 131a at one end portion, and a first capacitor 136a is provided between the first feeding portion 131a and the main conductive member 133. Since the first capacitors 136a are provided in series, the resonance frequency with respect to the main conductive member 133 may be increased. The main conductive member 133 may be fed by the second feeding portion 131b, and the second capacitor 136a is formed between the second feeding portion 131b and the main conductive member 133. A gap G1 is provided between the second capacitor 136a and the main conductive member 133 and spaced apart therefrom at predetermined intervals.

The main conductive member 133 may be fed by the third feeding portion 131c and a third capacitor 136a is formed between the third feeding portion 131c and the main conductive member 133. Gaps G2 and G3 are formed between the third capacitor 136a and the main conductive member 133 and spaced apart therefrom at predetermined intervals. Here, the gaps G1, G2, and G3 between the conductive members may be represented by capacitors in an equivalent circuit.

A gap G formed by the main conductive member 133 and the sub-conductive members 134b in an embodiment of the present disclosure is a kind of slit.

In this case, the resonance frequencies realized by the first to third feeding portions 131a, 131b and 131c may be different from each other. For example, when the resonance frequency realized by the first feeding portion 131a is F1, the resonance frequency realized by the second feeding portion 131b is F2, and the resonance frequency realized by the third feeding portion 131c is F3, F1<F2<F3. In this manner, by feeding using the multi-ports, the resonance frequencies of different frequency bands may be realized. Here, the first to third capacitors 136a serve as matching modules.

For example, in order to implement a resonance frequency of a mid-band in a range of 1.7 to 2.1 GHz, the first matching module 132a may have a size of 1 to 2 pF and have one gap G1. In order to implement a resonance frequency of a high band in a range of 2.5 to 2.7 GHz, the second matching module 132b may have a size of 1 to 2 pF and have two gaps G2 and G3. In addition, in order to implement a resonance frequency of a very high band in a rage of 3.3 to 3.5 GHz, the third matching module 132c may have a size of 1 to 2 pF and have three gaps G4, G5, and G6.

Here, capacities of the first to third matching modules 132a, 132b, and 132c may be different from each other. However, in an embodiment of the present disclosure, it is not easy to manufacture the first to third matching modules 132a, 132b, and 132c to have a size smaller than 0.1 pF or 0.05 pF.

Referring to FIG. 11, it can be seen that only one feeding portion 131 is connected to one main conductive member 133. The matching module 132 connected to the feeding portion 131 may include a plurality of lumped elements and may include an inductor 137b or a capacitor 136b as illustrated in FIG. 11. In FIG. 11, the matching module 132 includes a first capacitor 136a connected in series to the feeding portion 131, a first inductor 137a connected in series to the first capacitor 136a, and a second capacitor 136b and a second inductor 137b connected in parallel with the first inductor 137a. In this manner, the matching module 132 includes at least one capacitor 136a connected in series with the feeding portion 131.

Here, two or more capacitors 136a may be connected in series with the feeding portion 131, and in this case, the number of the sub-conductive members 134a and 134b may be reduced. FIG. 11 illustrates that two gaps G1 and G2 are formed between the frequency varying unit 135 and the main conductive member 133.

Meanwhile, a size of the gap in the embodiment of the present disclosure is preferably about 0.1 to 0.5 mm.

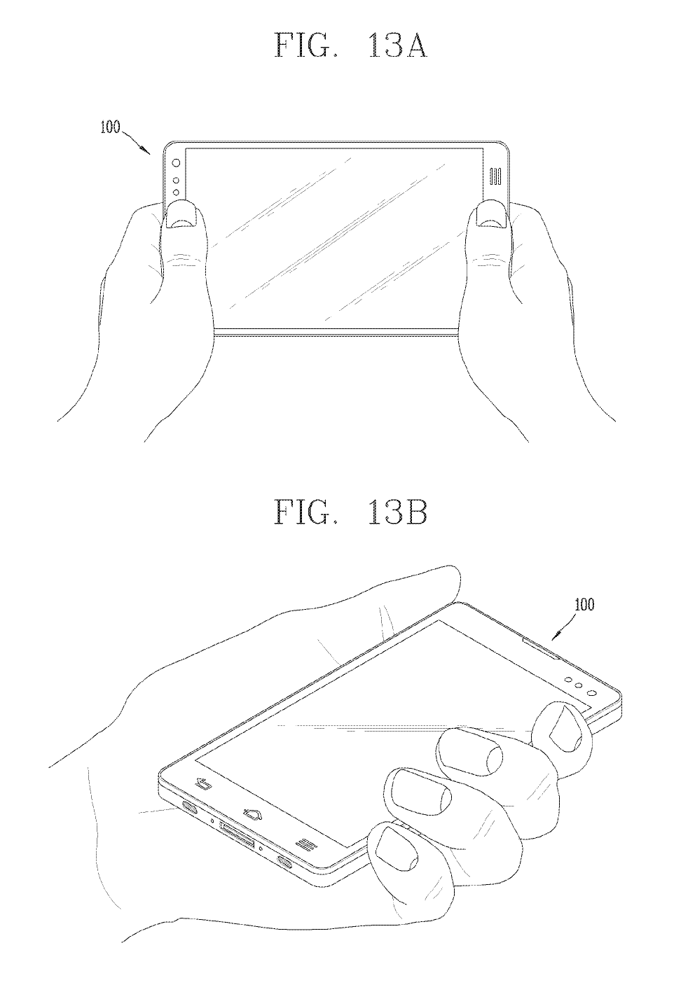

FIGS. 13A and 13B illustrate a state in which a user grips and uses the mobile terminal 100. FIG. 13A illustrates a state in which the user grips both end portions of the mobile terminal 100 which is horizontally disposed, and FIG. 13B illustrates a state in which the user holds the mobile terminal 100 which is vertically disposed, while wrapping up the rear side of the mobile terminal with his hand. A radiator of the upper antenna 130a may be an upper frame 111 forming an upper end surface of the mobile terminal 100, and a radiator of the lower antenna 130b formed at a lower portion of the mobile terminal 100 may be a lower frame 112 forming a lower end surface of the mobile terminal 100. Here, the upper antenna 130a may be fed by a feeding portion 131u, and the lower antenna 130b is fed by the feeding portion 131.

As described later, the radiators of the upper antenna 130a and the lower antenna 130b may be metal frames 111 and 112 forming the side surface of the mobile terminal 100 or a metal material cover 102 covering the rear surface of the mobile terminal 100.

As described above, the user often uses the mobile terminal 100 in a state of wrapping the top and/or bottom of the mobile terminal 100, which is a bezel portion of the mobile terminal 100, when using the mobile terminal 100. The antenna devices 130, 130a, and 130b for wireless communication are mainly disposed at edge portions of the mobile terminal 100 in order to improve radiation efficiency, and if the user wraps the radiation region of the antenna devices 130a and 130b installed in the mobile terminal 100, radiation efficiency is degraded.

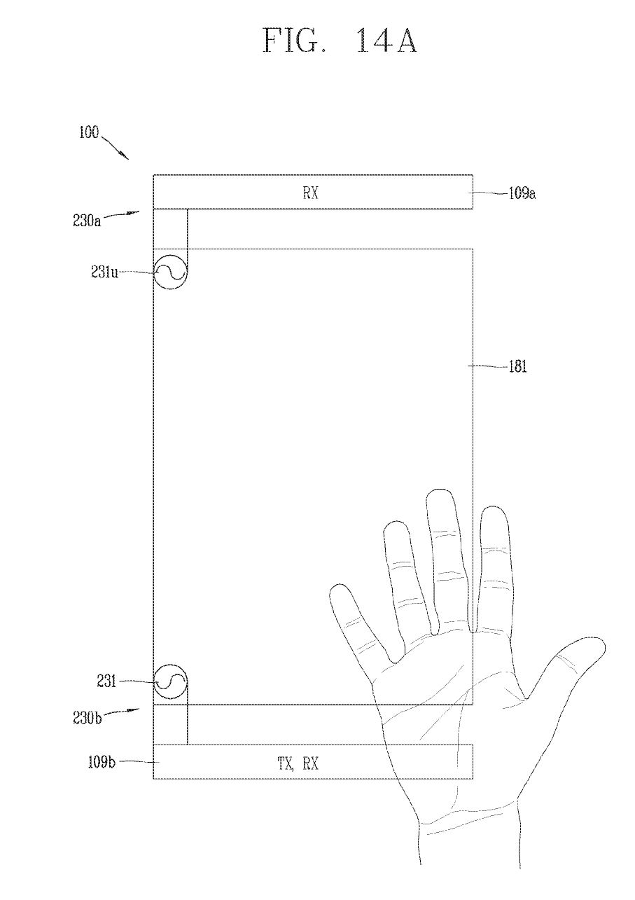

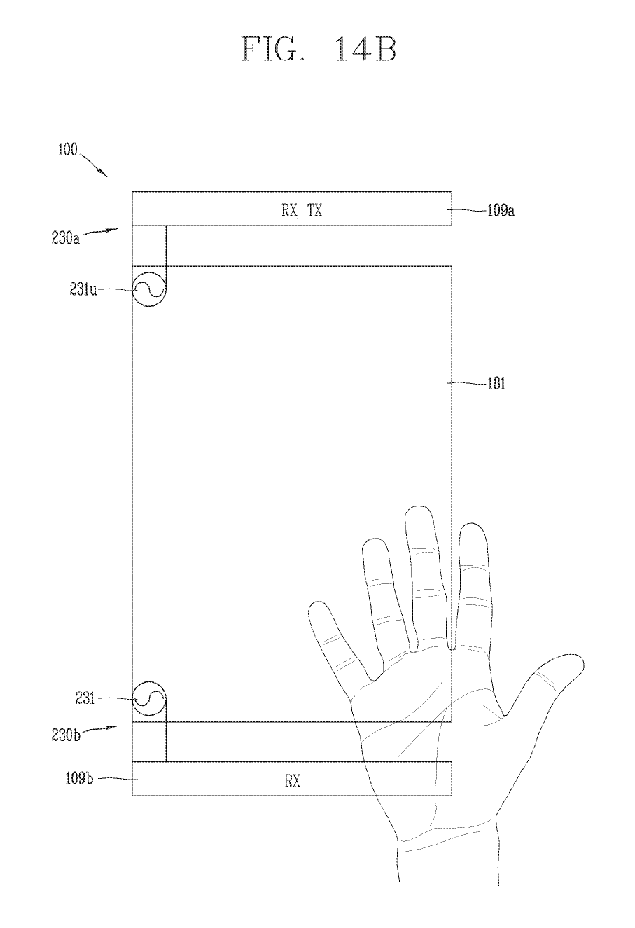

FIGS. 14A and 14B are diagrams for explaining an arrangement of the transmission/reception antenna devices 230a and 230b for wireless communication of the mobile terminal 100. FIG. 14A illustrates that an antenna device 230b for a transmitter (TX) circuit and a receiver (RX) circuit is disposed at a lower end of the mobile terminal 100 and a reception antenna 230a is disposed at an upper end of the mobile terminal. When both the antenna devices 230b for transmission and reception are fixed and disposed only at the lower portion of the mobile terminal 100, a depth grip phenomenon may occur due to the user's body. That is, a hand effect phenomenon in which radiation performance is hindered by the user's hand occurs. In order to solve this problem, If the antenna device 230a including the transmitter circuit RX and the receiver circuit TX is moved to the upper portion of the mobile terminal 100 as illustrated in FIG. 14B, the hand effect phenomenon may be alleviated but the problem of specific absorption rate (SAR) still remains.

In particular, in the case of radiation for transmission, if the radiation performance of the antenna device 230a is excellent, power may not need to be high, but if the radiation performance of the antenna device 230a is low power needs to be increased to implement the same quality of wireless communication.

In order to solve the problem, the mobile terminal 100 according to an embodiment of the present disclosure includes a transformation antenna device (feeding swap) changing a radiation direction and a radiation region of a radiator according to a state in which the user grips the mobile terminal 100.

An antenna device in an embodiment of the present disclosure relates to a technique of suppressing a phenomenon of hindrance of antenna performance by the user by changing a radiation pattern such as a radiation direction or a radiation region of a radiator by changing a position which is fed.

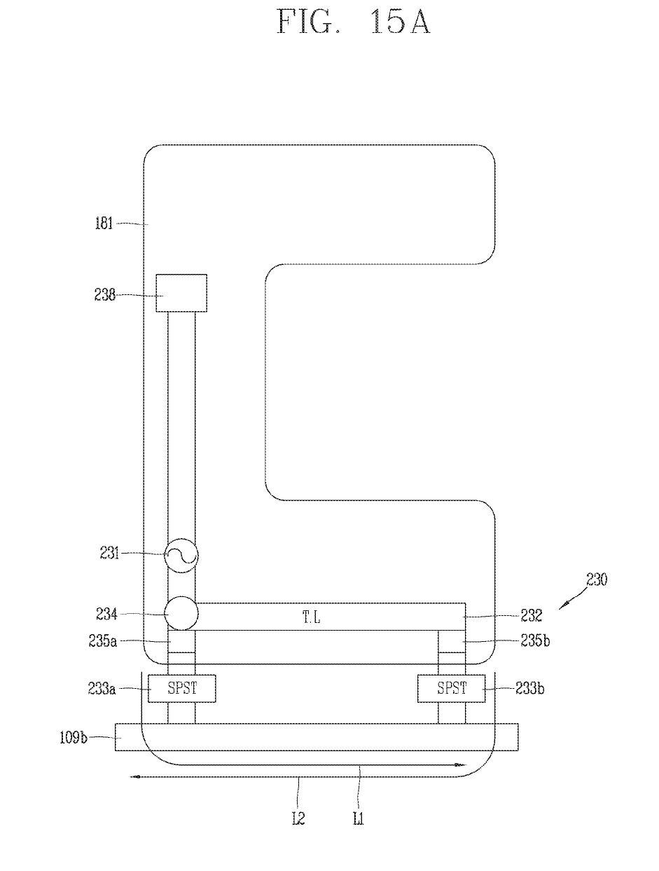

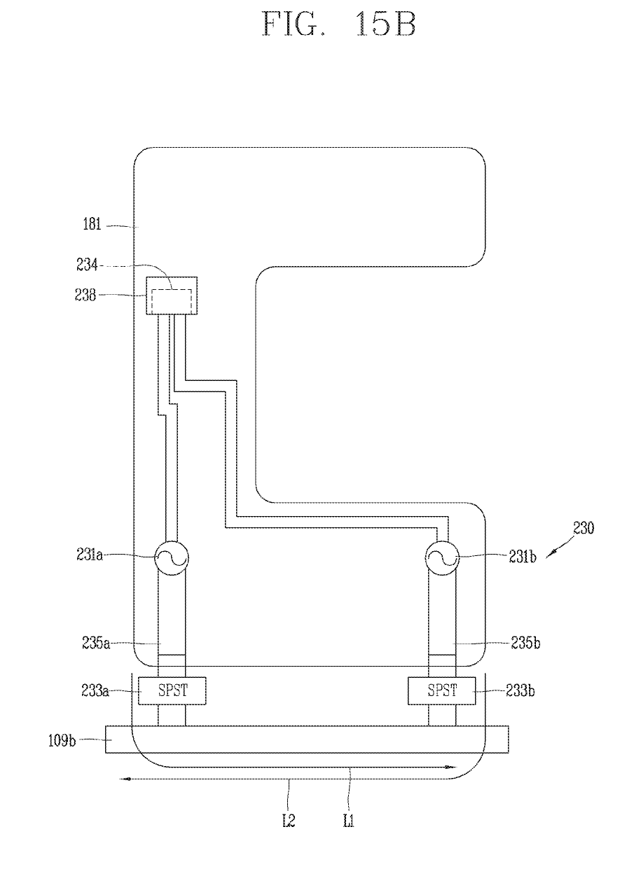

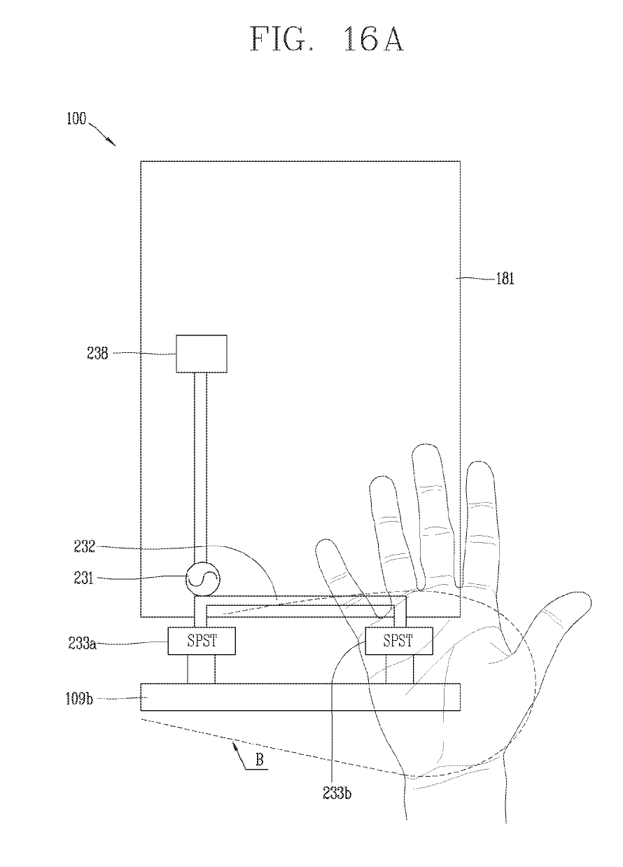

FIG. 15A is a conceptual diagram of an antenna device 230 according to an embodiment of the present disclosure, and FIGS. 16A and 16B are views for explaining a state in which the antenna device 230 of FIG. 15A is applied.

Referring to FIGS. 15A to 16B, a mobile terminal 100 according to an embodiment of the present disclosure includes a terminal body, a metal material case 109b forming an appearance of the terminal body and having at least a part which operates as a radiator of the antenna device 230, a feeding portion 231 feeding the metal case 109b, and a transmission line 232 disposed between the feeding portion 231 and the metal case 109b and extending along a formation direction of the metal case 109b, and first and second switches 233a and 233b.

Here, as illustrated in FIG. 1D, for example, the feeding portion 231 may be fed by coaxial cables 144 and 145 connected to the transceiver circuit 238.

In an embodiment of the present disclosure, the radiator of the antenna device 230 is a metal material case 109b forming an appearance of the mobile terminal 100 but the present disclosure is not limited thereto. For example, in case where feeding swap is required by the feeding portion, the contents described in the embodiment of the present disclosure may be applied.

The metal case 109b may be a lower frame 109b forming a lower side surface of the mobile terminal 100. The first switch 233a is connected to one side of the transmission line 232 and formed adjacent to one end portion of the radiator which is the metal case 109b to electrically connect the transmission line 232 and the radiator. The second switch 233b is connected to the other side of the transmission line 232 and formed adjacent to the other end portion of the radiator to electrically connect the transmission line 232 and the radiator 109b. Here, a path L1 formed by a current formed by way of the first switch 233a has a substantially L-shape, and a path L2 formed by a current formed by way of the second switch 233b has an inverted L shape.

In addition, a gap structure may be provided in a part of the metal case 109b. For example, the metal case 109b may be provided with one or more gaps. These gaps may be filled with a dielectric such as polymer, ceramics, glass, or the like. The gaps may separate the metal case 109b into one or more peripheral conductive member segments. For example, two segments of the metal case 109b may form two segments of the meta case 109b, three gaps may form three segments of the metal case 109b, four gaps may form four segments of the metal case 109b. The segments of the metal case 109b formed in this manner may form a part of the antenna.

Here, a radiation region of the radiator is varied by selectively operating the first and second switches 233a and 233b. Accordingly, the two paths L1 and L2 are not simultaneously formed but only one of them is formed. A branching switch 234 controls this.

Which of the first and second switches 233a and 233b is to be operated is determined by the RFIC 238. For example, in case where radiation of an electromagnetic wave by the path L1 by supplying a current to the first switch 233a is hindered, a current is immediately, automatically supplied to the second switch 233b to allow the electromagnetic wave to be radiated by the path L2. This function is controlled by the RFIC 238. That is, the RFIC 238 serves as a sort of controller.

More specifically, the RFIC 238 may be used to implement an antenna diversity scheme. Such a diversity scheme may support receiver diversity and/or transmitter diversity. For example, the RFIC 238 may include several receivers respectively associated with antennas or a multiplexer which may be used for routing signals from the antennas to a shared receiver (using time multiplexing array, for example). The receiver diversity may be implemented such that a receiver receiving the best antenna signal is used. A switching circuit allowing antennas to be swapped in real time may be included. For example, if it is determined that a specific antenna is blocked during a signal transmission operation, the switching circuit may be used to connect an active transmitter circuit present inside a device to an unblocked antenna.

If current flow only to the first switch 233a is generated and current flow to the second switch 233b is blocked by the branching switch 234, the path L1 may be formed (See FIGS. 15A and 16A). Meanwhile, if current flow to the first switch 233a is blocked and current flow only to the second switch 233b is generated by the branching switch 234, the path L2 may be formed (See FIGS. 15A and 16B). A maximum radiation point of the path L1 is a right side end portion of the lower frame 109b in FIG. 15A, and a maximum radiation point of the path L2 is a left side end portion of the lower frame 109b in FIG. 15A. Here, first and second matching portions 235a and 235b may be disposed between the branching switch 234 and the first and second switches 233a and 233b.

In an embodiment of the present disclosure, since the same resonance frequency must be implemented while using the same radiator 109b, a distance D1 from the first switch 233a to the other end portion of the radiator 109b and a distance D2 from the second switch 233b to one end portion of the radiator 109b must be equal.

Here, the other end portion of the radiator 109b refers to a part adjacent to the second switch 233b, among both end portions of the radiator 109b, and one end portion of the radiator 109b refers to a part adjacent to the first switch 233a, among both end portions of the radiator 109b. When D1 and D2 are equal, it means that electrical distances, as well as physical distances, are equal. Here, the electrical length refers to an electrical length of the radiator operating as an antenna, the physical distance D1 from the feeding portion 231 to the other end portion of the radiator 109b by way of the first switch 233a and the physical distance D2 from the feeding portion 231 to the one end portion of the radiator 109b by way of the second switch 233b are not necessary to be equal and electrical distance thereof may be equal.

An electric element for matching for adjusting an electrical length may be disposed at the transmission line 232. The electrical length may be a length which can be changed into a length of a wavelength unit and may vary according to paths of current, resistance, and the like. Resistance here may be changed by the combination of the lumped elements such as an inductor, a capacitor, and the like.

FIG. 16A shows a state in which the first switch 233a is turned on and the second switch 233b is turned off. Referring to FIG. 16a, when the first switch 233a is turned on, current flows to the right side in FIG. 16A by way of the first switch 233a and the metal case 109b. Since the second switch 233b is blocked, a main radiation region by the radiator 109b is a region ‘A’ adjacent to one end portion of the radiator, and when the user grips the right side in FIG. 16A, radiation performance deteriorates due to the user's body.

Meanwhile, FIG. 16B shows a state in which the first switch 233a is turned off and the second switch 233b is turned on. Referring to FIG. 16B, current supplied by the feeding portion 231 flows toward the end portion of the metal case 109b adjacent to the first switch 233a by way of the transmission line 232, the second switch 233b, and the metal case 109b. Due to the current flow, a radiation pattern in such a form as indicated by B is formed around the metal case 109b. In this case, there is no significant influence on radiation efficiency by the user's body.

In this manner, the phenomenon of a depth grip by the user may be suppressed by changing the radiation pattern (or radiation region), while using the same radiator.

In an embodiment of the present disclosure, as illustrated in FIGS. 16A and 16B, when a part of a user's body part wraps the mobile terminal 100 to hinder radiation performance of the antenna device 230, a degradation of performance of the antenna device 230 due to the user's body may be suppressed by changing a radiation direction or a radiation region, while having the same resonance. That is, flow of current may be automatically changed by the branching switch 234 so that main radiation may be performed through one end portion or the other end portion of the metal case 109b which is the radiator in FIG. 16A.

For example, as illustrated in FIG. 16A, in case where radiation performance of the radiator 109b deteriorates, a degradation of radiation performance of the antenna device 230b may be prevented by changing the main radiation region of the radiator 109b as illustrated in FIG. 16B. To this end, the resonance frequency radiated in FIG. 5A and the resonance frequency radiated in FIG. 16B must be in the same or similar band.

As described above, the flow of the current passing through the first switch 233a and the flow of the current passing through the second switch 233b are not generated at the same time but are selectively generated. To this end, the branching switch 234 is formed at a part connecting the feeding portion 231 and the transmission line 232. The branching switch 234 is provided between the feeding portion 231 and the transmission line 232 to selectively connect the current to the first and second switches 233a and 233b. The branching switch 234 is formed on at least one of both ends of the transmission line 232. That is, there may be only one branching switch 234 or two branching switches 234, but in any case, the electrical lengths of currents formed at both ends of the radiator 109b in the feeding portion 231 must be equal.

If the feeding portion 231 is one and the branching switch 234 is one, as illustrated in FIG. 15A, the feeding portion 231 may be formed independently adjacent to the first switch 233a and the feeding portion 231 may be formed independently adjacent to the second switch 233b.

In FIG. 15B, it is illustrated that the branching switch 234 is formed inside the transceiver circuit 238. In this case, two feeding portions 231 including a first feeding portion 231a formed to be adjacent to the first switch 233a and a second feeding portion 231b formed to be adjacent to the second switch 233b.

In addition, the branching switch 234 must be provided as two branching switches. In detail, as illustrated in FIG. 15B, the branching switch 234 is connected to the first feeding portion 231a to control flow of current to the first switch 233a or connected to the second feeding portion 231b to control flow of current to the second switch 233b. The branching switch 234 may not be formed inside the transceiver circuit 238 and may be connected to the transceiver circuit 238.

Here, when current is supplied to the metal case 109b via the first switch 233a, current is supplied to the first switch 233a by the branching switch 234, and at the same time, the first switch 233a is turned on and the second switch 233b is turned off. When current is supplied to the metal case 109b via the second switch 233b, current is supplied to the second switch 233b by the branching switch 234, and at the same time, the second switch 233b is turned on and the first switch 233a is turned off. As described above, according to an embodiment of the present disclosure, since current is selectively supplied through the first and second switches 233a and 233b, an isolation problem does not arise.

Here, as in the case of FIG. 15A, flow of the current through the first switch 233a is formed along the path L1 and flow of the current through the second switch 233b is formed along the path L2. Electrical lengths of the two paths L1 and L2 are equal.

In addition, as illustrated in FIG. 15B, in the case of using the branching switch 234, the transmission line 232 is unnecessary.

The first and second switches 233a and 233b may be contact relay switches as single pole single throw (SPST) switches, and the third and fourth switches 234a and 234b may be changeover relays as single pole double throw switches (SPDTs).

The feeding portion 231 for applying a signal to the metal case 109b is branched through the branching switch 234a at least near the metal case 109b. Further, in order to make the electrical lengths of the currents along the two paths L1 and L2 equal or similar to each other, the feeding portion 231 of the metal case 109b is made as symmetrical as possible to a connection portion connected to the metal case 109b.

In general, in order to minimize a performance degradation due to hand grip, a tuner for matching is used to compensate for matching efficiency. However, in an embodiment of the present disclosure, even radiation efficiency may be compensated using a beamforming phenomenon that occurs as the position of the feeding portion 231 is changed in order to minimize a performance degradation due to hand grip.

Meanwhile, the metal case 109b may form at least a part of one side surface or rear side surface of the terminal body. That is, the metal case 109b may use at least one of four side surfaces of the terminal body as a radiator of the antenna device 230, and a part of the metal cover covering the rear surface of the terminal body may be used as a radiator of the antenna device 230. A case where the metal case 109b forms the side surface of the terminal body may be referred to as a ring type and a case where the metal case 109b covers the rear surface of the terminal body may be referred to as a metal material cover type.

Generally, the position of the feeding portion 231 is generally a position of /4 of a low band. In an embodiment of the present disclosure, the positions of the first and second feeding portions 231a and 231b must be symmetrically implemented. Since the metal case is generally positioned to be symmetrical on both sides of a USB terminal (See socket 119 of FIG. 1) and a length of the metal case 109b exposed to the outside is long, the metal case may be used as a low band on one side and may be used as a mid-band or high band on the other side, regardless of the ring type or metal cover type.

The first and second switches 233a and 233b and the branching switch 234 may be mounted on the transmission line 232. The first and second switches 233a and 233b and the metal case 109b may be electrically connected by a C-clip 236. Here, the first and second switches 233a and 233b, the branching switch 234, and the transmission line 232 may be mounted on the main circuit board 181.

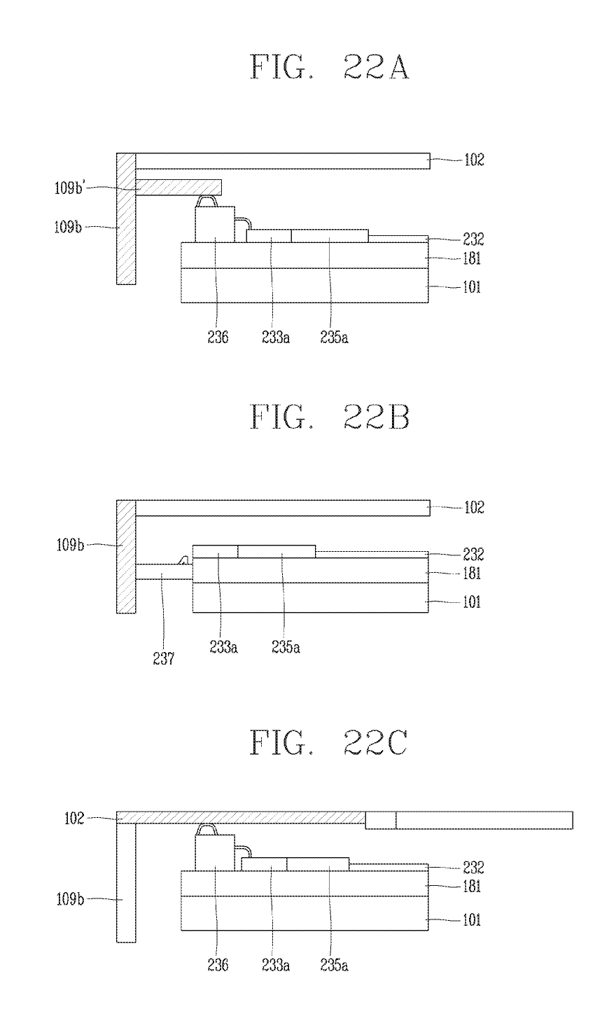

FIGS. 22A to 22C illustrate a configuration in which the metal case 109b is fed in an embodiment of the present disclosure. The branching switch (SPDT) 234 is formed at a position determined according to which of the first feeding portion 231a and the second feeding portion 231 b is to be used. As illustrated in FIGS. 22A to 22C, the first and second switches (SPST) 233a is formed at a position connected to an immediately rear end of the connection terminals 236 and 237 and a front end of the matching portion 235a. That is, as for flow of current, a signal line 186 is formed by the transmission line 232 and the matching lines 235a and 235b, the first and second switches 233a and 233b, the C-clip 236, and the metal case 109b are sequentially electrically connected to the transmission line. Here, the first and second switches 233a and 233b may be electrically connected to the transmission line 232 by the first and second matching portions 235a and 235b, respectively.

In FIG. 22A, it is illustrated that the metal case 109b is formed as a ring type and electrically connected to the connection terminal 236 by an auxiliary conductive member 109b′ protruding toward the inside from one point of the metal case 109b. According to this, the transmission line 232, the first and second matching portions 235, and the first and second switches 233a and 233b are formed on the main circuit board 181 in the mobile terminal 100, and the metal case 109b is fed through the connection terminal 236.

The metal case 109b may be fed by the C-clip 236 as illustrated in FIG. 22A, or may be connected through a generally used method such as a point-to-point contact scheme, or the like, as illustrated in FIG. 22B. Thereafter, the metal case is connected to the first and second switches (SPST) 233a and 233b, and thereafter, the matching portion 235 is connected. Here, the first and second switches 233a and 233b may utilize an active device, or the like, having an SPST function.

FIG. 22C shows a case where the rear case 102 is used as a part of the radiator, illustrating that the rear case 102 is fed through the connection terminal 236.

Here, a terminal electrically connecting two elements by a C-clip may be referred to as the first connection terminal 236, and a terminal electrically connecting two elements by a point-to-point contact scheme may be referred to as the second connection terminal 237.

Meanwhile, in the embodiment of the present disclosure, the transmission line 232 may be a flexible circuit board 182 which is formed of a flexible material, has at least one ground layer 183a and 183b, and allows an electronic component to be mounted thereon. The flexible circuit board 182 may be a sort of main printed circuit board (PCB) and may be a strip-line type flexible PCB.

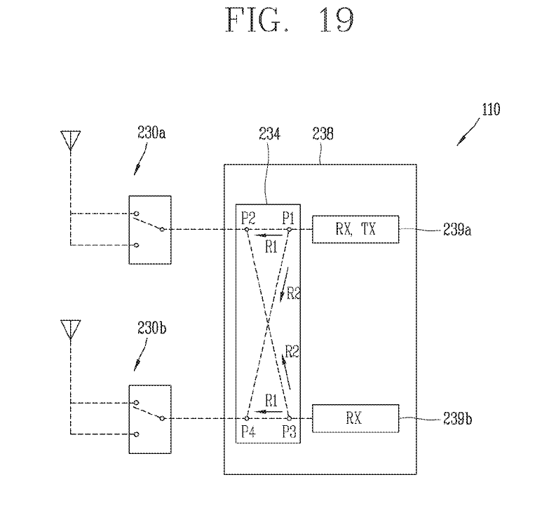

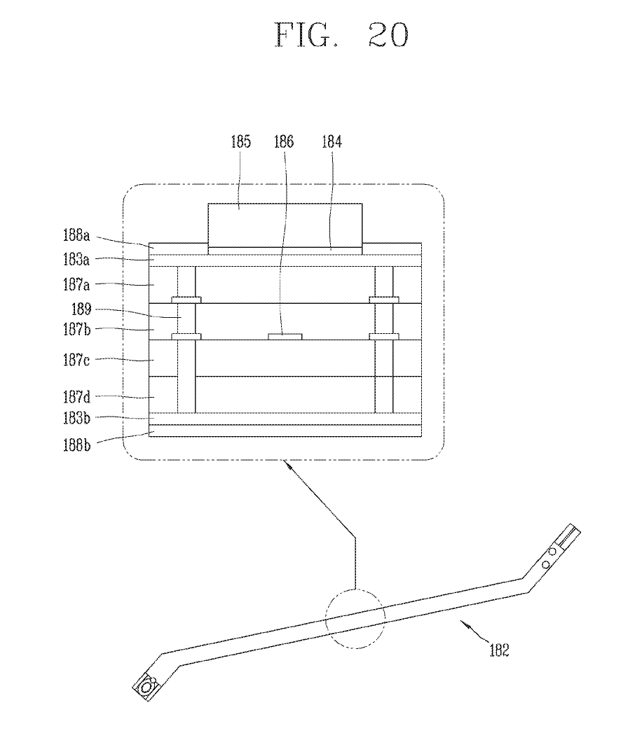

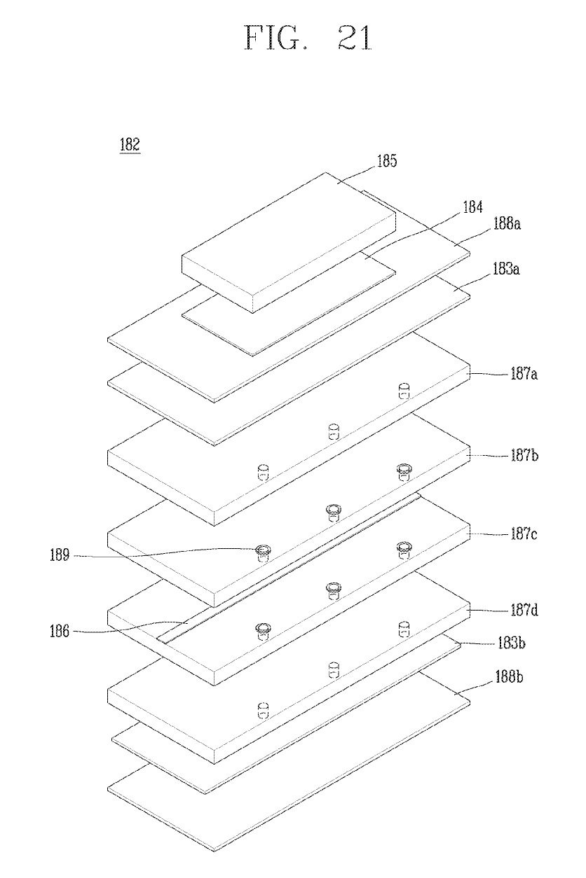

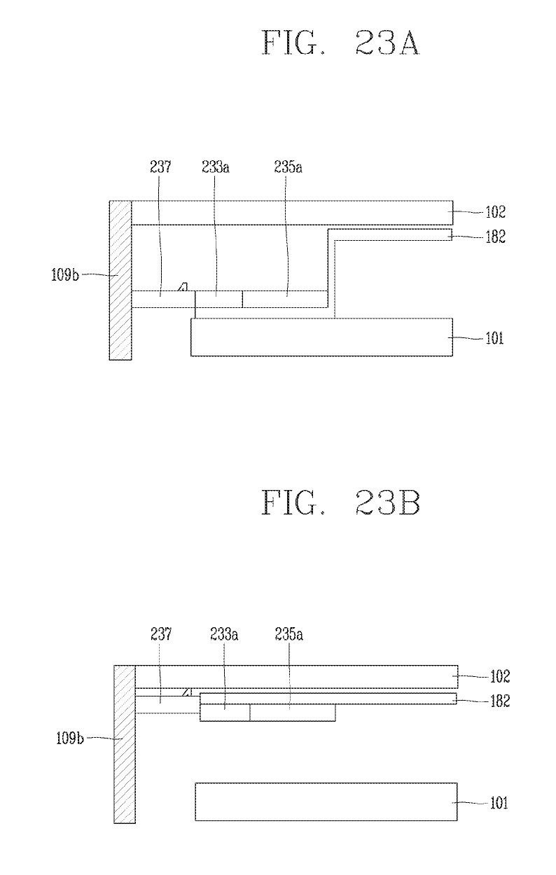

FIG. 20 is an overall exploded perspective view and a partial cross-sectional view of the flexible circuit board 182 according to an embodiment of the present disclosure, FIG. 21 is an exploded perspective view of the flexible circuit board 182 according to an embodiment of the present disclosure, and FIGS. 23A and 23B are views each for explaining a configuration in which the flexible circuit board 182 is implemented in the mobile terminal 100. Referring to FIGS. 20, 21, 23A and 23B, the flexible circuit board 182 according to an embodiment of the present disclosure includes two ground layers 183a and 183b and a signal line 186 positioned between the two ground layers 183a and 183b. Here, a conductive tape 185 is provided at the uppermost layer and adhered to a metal material or plastic (PC). In an embodiment of the present disclosure, utilizing an advantage of the FPCB 182, the conductive tape is adhered to the inside of the case 109b as illustrated in FIGS. 23A and 23B to allow for signal transmission.

As described above, the main circuit board 181 may be disposed only on one side of the USB and, when it is difficult to arrange the main circuit board 181 on the other side due to an insufficient space for mounting, an antenna may be formed by separately using an RF signal.

In this case, the flexible circuit board 182 may be bent or implemented as a straight line. In FIGS. 21, 23A, and 23B, the flexible circuit board 182 is formed on two upper and lower ground layers 183a and 183b, and the ground layers 183a and 183b are removed from a section where the matching portion 235a is required, and the matching portion 235a, the switch 233a, the C-clip 236, and the like, are mounted, like a general circuit board.

More specifically, the flexible circuit board 182 is a multilayer circuit board including first and second ground layers 183a and 183b at upper and lower portions thereof, a via hole 189, and a plurality of layers 187a, 187b, 187c, and 187d which are stacked. A pair of solder resists 188a and 188b are formed on upper and lower surfaces and a plating layer 184 is formed between the first ground layer 183a and the conductive tape 186.

First and second switches 233a and 233b and the branching switch 234 may be formed at both end portions of the flexible circuit board 182.

As described above, in an embodiment of the present disclosure, a main radiation region may be changed to suppress a degradation of radiation performance of the antenna device 230 due to a user's body contact, or the like. In the drawings, it is illustrated that the antenna device 230 radiates electromagnetic waves mainly from a left side end portion and a right side end portion at a lower portion of the mobile terminal 100, but the present disclosure is not limited thereto and the main radiation region of the antenna device 230 may be changed at an upper side end portion and a lower side end portion of the mobile terminal.

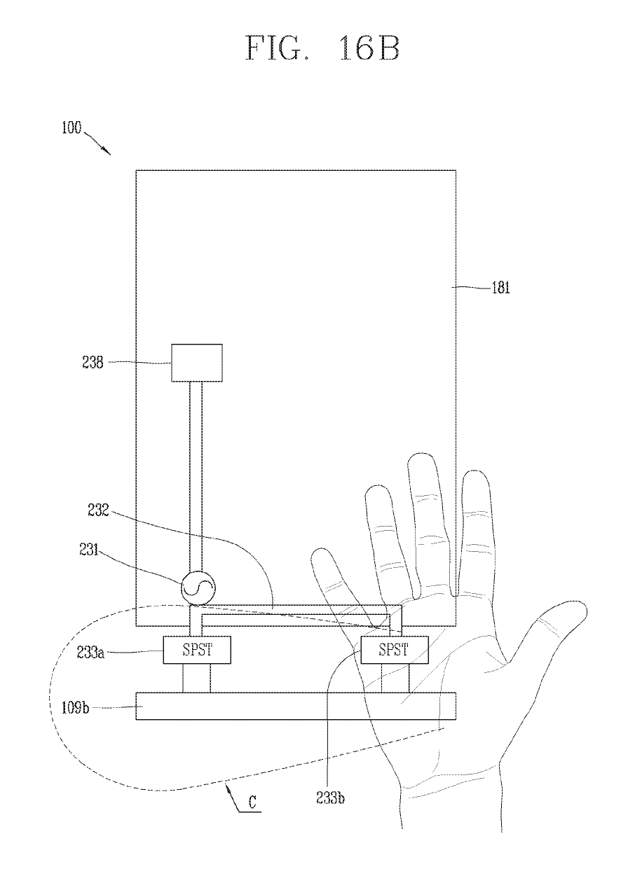

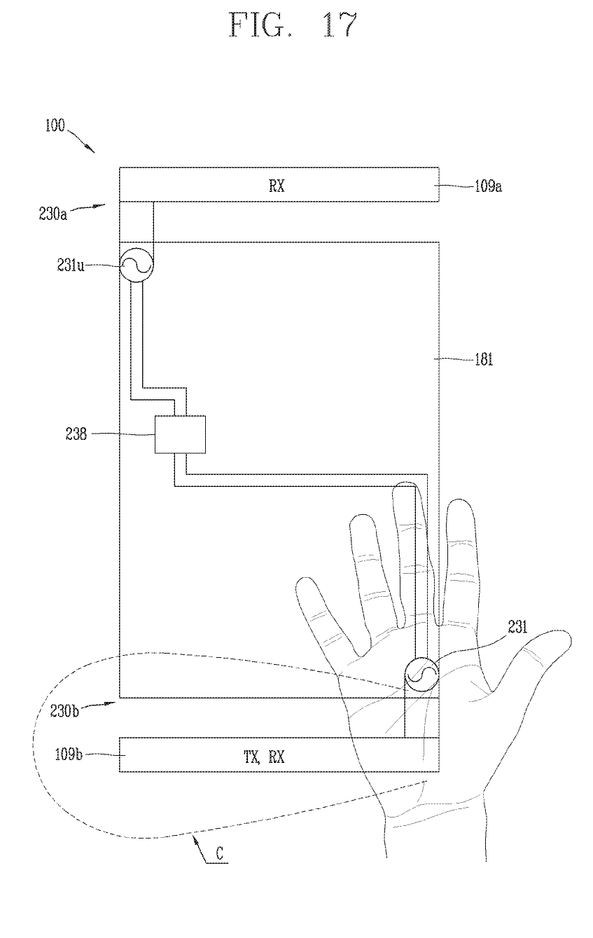

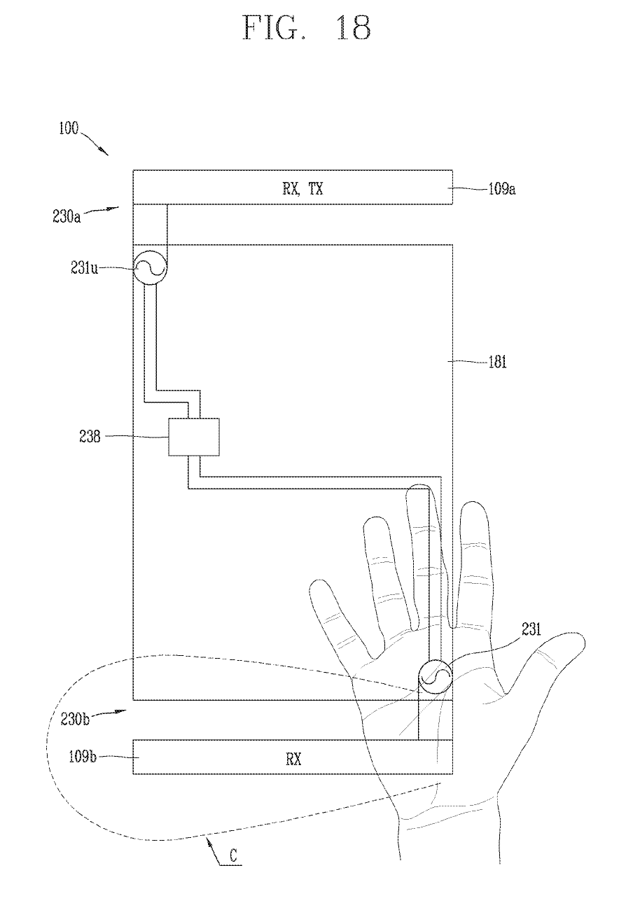

FIG. 17 is a view for explaining a state in which a transmitter circuit TX according to an embodiment of the present disclosure is formed at a lower end of the mobile terminal 100, FIG. 18 is a view illustrating a state in which the transmitter circuit TX according to an embodiment of the present disclosure is formed at an upper end of the mobile terminal 100, and FIG. 19 is a view for explaining an arrangement of an upper antenna and a lower antenna according to an embodiment of the present disclosure.

Hereinafter, descriptions will be given with reference to FIGS. 17 to 19.

In FIGS. 15A to 16B, replacement of a radiation pattern radiated to the left and right sides of the mobile terminal 100 is described. Hereinafter, replacement of a radiation pattern radiated to upper and lower sides of the mobile terminal 100 will be described.

In particular, from the perspective of a transmitter, among the antenna devices 230a and 230b, as antenna radiation performance is enhanced, a magnitude of applied power is reduced. Therefore, in general, in some cases, the transmitter disposed at a lower portion of the mobile terminal 100 may need to be disposed at an upper portion of the mobile terminal 100.

In FIG. 17, the mobile terminal 100 in which the transmitter circuit TX is implemented at the lower antenna 230b, the receiver circuit RX is implemented at the upper antenna 230a, and radiation performance due to the user's hand is not lowered is illustrated. Unlike the case of FIG. 17, FIG. 18 illustrates that the transmitter circuit TX is implemented by the upper antenna 230a. That is, by using the upper antenna 230a and the lower antenna 230b having the same structure, any one of the upper frame 109a and the lower frame 109b may be used as a radiator for transmitting data.

FIG. 19 is a conceptual diagram of the mobile terminal of FIG. 18, illustrating that the transmitter circuit TX may be implemented by the upper antenna 230a.

For example, in case where a game is played in a state in which the mobile terminal 100 is disposed horizontally, as illustrated in FIG. 23B, when most of the lower portion of the mobile terminal 100 is in contact with the user's body, it is preferred that the upper antenna 230a provided on the upper side of the mobile terminal 100 is actively utilized.

Here, whether the transmitter circuit TX is to be implemented at the upper antenna 230a or whether the transmitter circuit TX is to be implemented at the lower antenna 230b is determined by the RFIC 238. That is, in an embodiment of the present disclosure, the upper frame 111 and the lower frame 109b operate as the radiators of the upper antenna 230a and the lower antenna 230b, respectively, and a transmission antenna may be selectively implemented in the upper antenna 230a or the lower antenna 230b.

Since the configuration of the upper antenna 230a may be the same as that of the lower antenna 230b, a detailed description of the upper antenna 230a is omitted. That is, an upper antenna 230a capable of selectively changing the radiation pattern is also implemented at an upper portion of the mobile terminal 100.

Referring to FIG. 19, the wireless communication unit 110 includes the upper antenna 230a, the lower antenna 230b, and the RFIC 238. The RFIC 238 includes a transceiver circuit 239a and a receiver circuit 239b therein.

The wireless communication unit 110 may include one or more integrated circuits, a power amplifier circuit, a low noise input amplifier, a passive radio frequency (RF) component, one or more antennas, and an RF transceiver circuit formed as a different circuit processing an RF wireless signal. Here, the wireless signal may also be transmitted using light (e.g., using infrared communication).

The wireless communication unit 110 may include one or more antennas 230a and 230b. The antennas 230a and 230b may be formed using any suitable antenna type. For example, the antennas 230a and 230b may include a loop antenna structure, a patch antenna structure, an inverted F antenna structure, an open/close slot antenna structure, a planar inverted F antenna structure, a helical antenna structure, a strip antenna, and an antenna having a resonance element formed by a monopole, a dipole, and a hybrid design, etc. Further, types of antennas according to different bands and a combination of bands may be used. For example, a type of antenna may be used to form a local radio link antenna and another type of antenna may be used to form a remote radio link antenna.

In addition, a branching switch 234 for determining which of the upper antenna 230a or the lower antenna 230b the transceiver circuit 239a is to be formed may be provided. Although the branching switch 234 is illustrated inside the RFIC 238 in FIG. 19, the branching switch 234 is not necessarily limited thereto and may be connected to the transceiver circuit 239a and the receiver circuit 239b. That is, the RFIC 238 may include one or more transmitters and one or more receivers, and may be coupled to the upper antenna 230a or the lower antenna 230b using the branching switch 234. The branching switch 234 may be controlled by a control signal, and the branching switch 234 may also be referred to as a switching circuit.

The branching switch 234 includes first to fourth ports P1, P2, P3, and P4 and the transceiver circuit 239a is implemented at the upper or lower antenna 230a or 230b according to connection states of the first to fourth ports P1, P2, P3, and P4. If the transceiver circuit 239a is connected to the upper antenna 230a through the first and second ports P1 and P2 and the receiver circuit 239b is connected to the lower antenna 230b through the third and fourth ports P3 and P4, the transceiver circuit 239a is implemented in the upper antenna 230a and the receiver circuit 239b is implemented in the lower antenna 230b.

Conversely, if the transceiver circuit 239a is connected to the lower antenna 230b through the first port P1 and the fourth port P4 and the receiver circuit 239b is connected to the upper antenna 230a through the third port P3 and the second port P2, the transceiver circuit 239a is implemented in the lower antenna 230b and the receiver circuit 239b is implemented in the upper antenna 230a.

Here, the former may be referred to as a first route R1 and the latter may be referred to as a second route R2.

More specifically, when the first control signal is input to the branching switch 234, the branching switch 234 is set to the first route R1, and in this operation mode, the first port P1 is connected to the second port P2 and the third port P3 is connected to the fourth port P4. When the first and second ports P1 and P2 are connected, a transmission signal from the transceiver circuit 239a is transmitted to the upper antenna 230a and an incoming signal from the upper antenna 230a is transmitted to the transceiver circuit 239a. Also, when the third and fourth ports P3 and P4 are connected, an incoming signal from the lower antenna 230b is transmitted to the receiver circuit 239b.

Meanwhile, when a second control signal is input to the branching switch 234, the branching switch 234 is set to the second route R2. In this operation mode, the first port P1 is connected to the fourth port P4 and the third port P3 is connected to the second port P2. When the first port P1 and the fourth port P4 are connected, a transmission signal from the transceiver circuit 239a is transmitted to the lower antenna 230b and an incoming signal from the lower antenna 230b is transmitted to the transceiver circuit 239a. Also, when the third port P3 and the second port P2 are connected, an incoming signal from the upper antenna 230a is transmitted to the receiver circuit 239b.

As a result, in an embodiment of the present disclosure, by making any one of the left and right end portions of the same radiator be the main radiation region, a degradation of antenna performance due to a hand effect phenomenon may be prevented, and in addition, by selectively disposing the transmitter circuit in any one of the upper end and lower end of the mobile terminal 100, SAR may be improved.

The present invention described above may be implemented as a computer-readable code in a medium in which a program is recorded. The computer-readable medium includes any type of recording device in which data that can be read by a computer system is stored. The computer-readable medium may be, for example, a hard disk drive (HDD), a solid-state disk (SSD), a silicon disk drive (SDD), a ROM, a RAM, a CD-ROM, a magnetic tape, a floppy disk, an optical data storage device, and the like. The computer-readable medium also includes implementations in the form of carrier waves (e.g., transmission via the Internet). Also, the computer may include the controller 180 of the terminal. Thus, the foregoing detailed description should not be interpreted limitedly in every aspect and should be considered to be illustrative. The scope of the present invention should be determined by reasonable interpretations of the attached claims and every modification within the equivalent range are included in the scope of the present invention.

### INDUSTRIAL APPLICABILITY

The present invention relates to a mobile terminal having an antenna, which may be utilized in various industrial fields.

1. A mobile terminal comprising:
a terminal body;
a main circuit board provided inside the terminal body;
a main conductive member spaced apart from the main circuit board and radiating an electromagnetic wave from an end portion thereof; and
a frequency varying unit provided between the main conductive member and the main circuit board and varying a resonance frequency regarding the main conductive member,
wherein the frequency varying unit includes:
a feeding portion connected to the main circuit board; and
at least one sub-conductive member disposed between the main conductive member and the feeding portion, spaced apart from each other, and fed by the feeding portion,
wherein the sub-conductive member and the main conductive member are spaced apart from each other at a predetermined interval.

2. The mobile terminal of claim 1, wherein
a matching module including a capacitor connected in series to the feeding portion is connected to the feeding portion.

3. The mobile terminal of claim 1, wherein
the main conductive member and the sub-conductive member are metal members and a size of a region in which the main conductive member and the sub-conductive member overlap is 1 to 3 mm.

4. The mobile terminal of claim 1, wherein
the terminal body includes a first body occupying most of the mobile terminal and a second body detachably attached to a lower portion of the first body,
wherein the second body includes:
a first member exposed to a front surface of the second body;
a second member exposed to a rear surface of the second body; and
a connection portion connecting end portions of the first and second members.

5. The mobile terminal of claim 4, wherein
the connection portion is formed of a metal material and the main conductive member is a part of the connection portion.

6. The mobile terminal of claim 4, wherein
the first member is formed of a non-metal material, and
the main conductive member is formed in a carrier spaced apart from the main circuit board and radiating an electromagnetic wave through the first member.

7. The mobile terminal of claim 1, wherein
a resonance frequency realized by the sub-conductive members is 4 GHz or higher.

8. The mobile terminal of claim 2, wherein
the frequency varying unit is provided in plurality, and
resonance frequencies realized respectively by the plurality of frequency varying units are different.

9. The mobile terminal of claim 1, wherein
as the length of the main conductive member is reduced, the number of the sub-conductive members is increased.

10. The mobile terminal of claim 2, wherein
the matching module further includes at least one lumped element connected in series or in parallel to the capacitor.
